(19) United States
(12) Patent Application Publication
(10) Pub. No.: US 2026/0367259 A1
(43) Pub. Date: Nov. 19, 2026

(54) TRACKING PEDESTRIAN ACTIVITY UTILIZING CALIBRATED INERTIAL DATA

(71) Applicant: Apple Inc., Cupertino, CA (US)

(72) Inventors: Kenneth M. Pesyna, JR., San Jose, CA (US); Halil Ibrahim Basturk, San Jose, CA (US); Christina Selle, Los Altos, CA (US); Jun Kyu Lee, San Jose, CA (US)

(73) Assignee: Apple Inc., Cupertino, CA (US)

(21) Appl. No.: 19/651,512

(22) Filed: Apr. 17, 2026

Related U.S. Application Data
(60) Provisional application No. 63/808,052, filed on May 19, 2025.

(51) Int. Cl. G01S 19/47; G01C 21/00

(52) U.S. Cl. CPC G01S 19/47; G01C 21/3881

(57) ABSTRACT

The disclosed techniques may include receiving global navigation satellite system (GNSS) data. The techniques may include receiving inertial data that is measured by an electronic device. The techniques may include determining that the electronic device is recording pedestrian activity of a particular type. Moreover, the techniques may include determining that the electronic device is in a particular signal environment. Also, the techniques may include, responsive to determining that the electronic device is recording the pedestrian activity in the particular signal environment, calibrating the inertial data using the global navigation satellite system (GNSS) data to generate calibrated inertial data. The techniques may include corresponding methods, systems, devices, and non-transitory computer readable mediums.

### CROSS-REFERENCE TO RELATED APPLICATION

This application claims the benefit of U.S. Provisional Application No. 63/808,052, filed May 19, 2025, the disclosure of which is incorporated by reference herein.

### BACKGROUND

Global navigation satellite system (GNSS) location determinations may be used to record pedestrian activity including walks, hikes, and runs. However, accurate GNSS localization may be difficult in some signal environments. For example, multipath errors caused by signal reflections off of tall buildings can cause inaccurate distance measurements and unstable location determinations in dense urban environments. Accordingly, GNSS techniques may not provide accurate location tracking in some environments.

### BRIEF SUMMARY

One aspect of the disclosure provides for a method that may include receiving global navigation satellite system (GNSS) data, receiving inertial data that is measured by an electronic device, determining that the electronic device is recording pedestrian activity of a particular type, determining that the electronic device is in a particular signal environment, responsive to determining that the electronic device is recording the pedestrian activity in the particular signal environment, generating calibrated movement data by calibrating the inertial data using the global navigation satellite system (GNSS) data.

Implementations may include one or more of the following features. Generating the calibrated movement data further may include removing outliers from the global navigation satellite system (GNSS) data using the calibrated inertial data. The method may further include computing a distance and a pace for the pedestrian activity using the calibrated movement data. Determining that the electronic device is in the particular signal environment may include determining a tile in a map that corresponds to the global satellite navigation system (GNSS) data, accessing signal environment information for the tile, and determining that the electronic device is in the particular signal environment based on the signal environment information. Receiving the GNSS data may further comprise determining one or more GNSS signal conditions. The GNSS signal conditions may comprise one or more of a GNSS signal strength, an elevation, an azimuth, and one or more multipath indicators. Determining that the electronic device is in the particular signal environment may comprise comparing the one or more GNSS signal conditions against one or more thresholds to identify the particular signal environment. The method may further include displaying a path of the pedestrian activity on the map using the calibrated movement data. The particular type may be a walk, a hike, or a run. The particular signal environment may be a dense urban environment, a tunnel, or a canyon. The global navigation satellite system (GNSS) data may be collected at a 1 hertz (Hz) frequency. The global navigation satellite system (GNSS) data may be measured by a first processor of the electronic device, and the inertial data is measured by a second processor of the electronic device, wherein the second processor is active for a larger proportion of time than the first processor. The particular signal environment may be an obstructed signal environment. The particular signal environment may be an urban signal environment. Determining the pedestrian activity of the particular type may comprise determining a carrying type and a gait type for the pedestrian activity, where the carrying type may include one of hand carrying and pocket carrying and the gait type may include one of walking, stair climbing, and running.

One aspect of the disclosure provides for one or more non-transitory computer-readable media computer-executable instructions that, when executed by one or more processors of an electronic device, cause the electronic device to perform operations that may include receiving global navigation satellite system (GNSS) data, receiving inertial data that is measured by an electronic device, determining that the electronic device is recording pedestrian activity of a particular type, determining that the electronic device is in a particular signal environment, and responsive to determining that the electronic device is recording the pedestrian activity in the particular signal environment, generating calibrated movement data by calibrating the inertial data using the global navigation satellite system (GNSS) data.

Implementations may include one or more of the following features. Generating the calibrated movement data further may include removing outliers from the global navigation satellite system (GNSS) data using the calibrated inertial data. Determining that the electronic device is in the particular signal environment may include determining a tile in a map that corresponds to the global satellite navigation system (GNSS) data, accessing signal environment information for the tile, and determining that the electronic device is in the particular signal environment based on the signal environment information.

One aspect of the disclosure provides for a mobile device may include a memory having computer-executable instructions and a processor configured to access the memory and execute the computer-executable instructions to perform operations including receiving global navigation satellite system (GNSS) data, receiving inertial data that is measured by an electronic device, determining that the electronic device is recording pedestrian activity of a particular type, determining that the electronic device is in a particular signal environment, responsive to determining that the electronic device is recording the pedestrian activity in the particular signal environment, generating calibrated movement data by calibrating the inertial data using the global navigation satellite system (GNSS) data.

Implementations may include one or more of the following features. Determining that the electronic device is in the particular signal environment may include determining a tile in a map that corresponds to the global satellite navigation system (GNSS) data, accessing signal environment information for the tile, and determining that the electronic device is in the particular signal environment based on the signal environment information.

### BRIEF DESCRIPTION OF THE DRAWINGS

FIG. 1 is a simplified diagram and flowchart showing a technique for calibrating inertial data according to various embodiments.

FIG. 2 is a simplified diagram of an architecture for tracking pedestrian activity using calibrated inertial data according to various embodiments.

FIGS. 3A-3B are graphs showing comparisons between GNSS data and raw inertial data according to various embodiments.

FIG. 4 shows simplified maps with inertial data according to various embodiments.

FIG. 5 is a flowchart illustrating a method for calibrating inertial data according to various embodiments.

FIG. 6 is a schematic diagram of a communication system according to various embodiments.

FIG. 7 is a block diagram of user equipment for implementing a communication system according to various embodiments.

FIG. 8 is a functional diagram of user equipment for implementing a communication system according to various embodiments.

FIG. 9 is a simplified diagram of an architecture for GNSS navigation according to various embodiments.

FIG. 10 is a block diagram of an example electronic device according to various embodiments.

FIGS. 11A-11F show example application programming interfaces (APIs), according to at least one embodiment.

### DETAILED DESCRIPTION

An electronic device can use location determinations for various purposes. For example, a fitness tracking application can monitor the device's location during a run. The runner may use the fitness tracking application during the run to view metrics about their workout including distance and pace. After the workout, the location determinations can be used to produce a map showing the runner's route. However, conventional location determination techniques may not work well in all environments.

An electronic device can determine its location using a global navigation satellite system (GNSS). The system's satellites broadcast signals from known positions, and the electronic device can use these signals to triangulate its location relative to the known satellite positions. The electronic device can determine the time-of-flight for each signal by comparing the signal's transmission time to the signal's reception time at the electronic device's receiver. A signal's time-of-flight and propagation speed can be used to calculate a distance between the receiver and the satellite, and the electronic device can use multiple distances to triangulate its position relative to the satellites.

GNSS techniques generally assume a line-of-sight path between the satellites and the electronic device because time-of-flight is used to determine distances for triangulation. However, the path between a receiver and satellite may be obstructed in some environments. For example, the path between an electronic device and a satellite may be blocked by buildings in an urban environment. Instead of a line-of-sight path, a satellite's signal may arrive at the electronic device's receiver after reflecting off of a building. The time-of-flight for a reflected signal is longer than the time-of-flight for a line-of-sight path, and, consequently, a reflected signal may cause an electronic device to calculate an incorrect distance to the satellite. This error causes the electronic device to triangulate its position at an incorrect location that is further from the satellite than the device's actual location.

Reflected signal paths can cause erratic GNSS location determinations. Instead of a consistent error that can be accounted for, the number of reflections can vary significantly as the electronic device travels over short distances. For example, a first signal from a satellite may be received via a line-of-sight path because the electronic device is next to an empty lot, but the next signal from the satellite may reflect several times as the device passes near a tall building. The variations in the number of reflections can mean that successive GNSS location determinations may vary by hundreds of meters. This variance means that GNSS data can include a large number of outliers in particular signal environments.

Inertial odometry (IO) techniques can be used to improve GNSS location determination accuracy in particular signal environments. An electronic device that implements inertial odometry techniques can estimate changes to the device's position and/or orientation over time using data from inertial sensors including accelerometers, gyroscopes, and/or magnetometers. Inertial odometry techniques can be equally accurate in most signal environments because communication with another device is not required to generate inertial data.

However, inertial odometry techniques may not be sufficiently accurate for location determinations without GNSS data. Inertial odometry techniques can accurately estimate changes in a device's position and/orientation over short periods of time, but the estimate's accuracy may drift over longer periods of time. Each inertial odometry estimate is a change in the position and/or orientation of the electronic device relative to the device's last position and/or orientation. Accordingly, an error in one inertial odometry estimate can propagate to all subsequent estimates and these errors can accumulate over time.

Unlike GNSS location determinations, which are coordinates in a global reference frame, inertial odometry estimates are generally in a session reference frame. Each inertial odometry estimate is a change in the position and/or orientation of an electronic device relative the device's initial position and orientation, but these estimates are not an absolute position of the electronic device in a coordinate system. For example, an electronic device can determine a vector between two GNSS location determinations that were measured by separate devices at separate times. In contrast, an inertial odometry estimate can only be used to determine a relative position to other estimates that were generated by the same device during the same inertial odometry session.

The limitations of GNSS and inertial odometry techniques can be mitigated by combining these two technologies to generate calibrated inertial data. GNSS data can be used to transform inertial odometry estimates into the GNSS reference frame. Essentially, an inertial odometry estimate can be mapped to GNSS coordinates that were generated at roughly the same time (e.g., within a time threshold). The inertial odometry data can be used to improve the GNSS data by identifying erratic location determination that were caused by signal reflections. For example, a large movement between GNSS location determinations, without a similarly large movement in inertial odometry data, may mean that one of the GNSS location determinations is an outlier.

### I. Calibrating Inertial Data

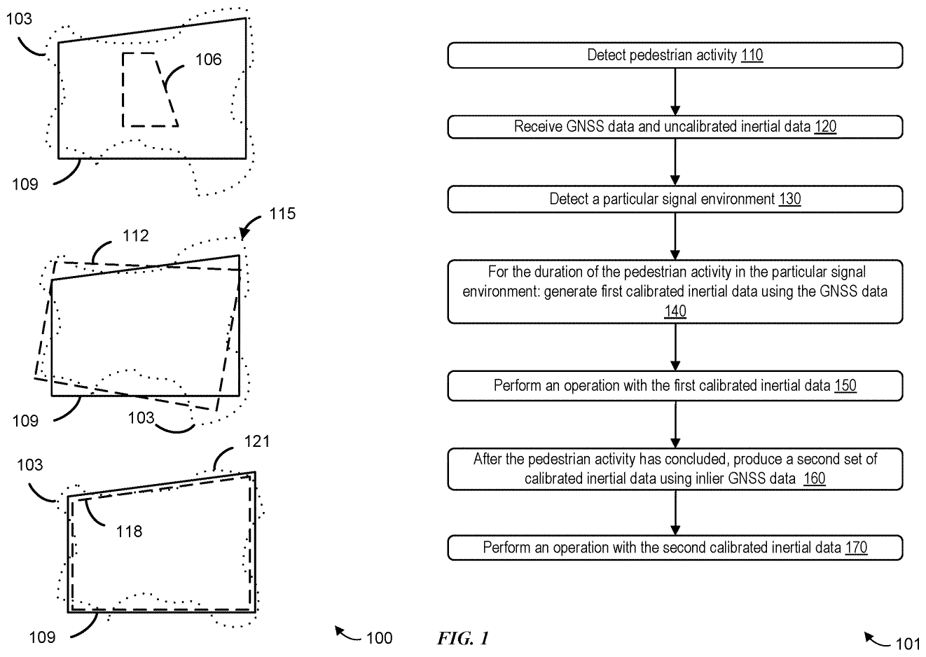

FIG. 1 is a simplified diagram 100 and a method 101 of a technique for calibrating inertial data according to various embodiments. In some implementations, one or more method blocks of method 101 may be performed by a mobile device (e.g., user equipment 12, architecture 800, electronic device 1000). In some implementations, one or more blocks of method 101 may be performed by another device or a group of devices separate from or including the mobile device. Additionally, or alternatively, one or more blocks of method 101 may be performed by one or more components of the mobile device, such as processor 22, memory 24, nonvolatile storage 26, input structures 30, network interface 34, sensors 37, GNSS receiver 48, antenna 50, application processor 905, receiver 910, antenna 925a-925n, location manager 935, input components 950, wireless circuitry 965, auxiliary processor 970, inertial sensor(s) 980, processor 1018, computer-readable medium 1002, Input/Output (I/O) subsystem 1006, wireless circuitry 1008, etc.

Diagram 100 shows global satellite navigation system (GNSS) data 103 and uncalibrated inertial odometry data 106. This data can be generated by an electronic device as the device moves along path 109. For example, path 109 can be a city block and the data can be generated as the device's user runs laps around the block.

Turning now to method 101 in greater detail, at block 110, pedestrian activity can be detected. The pedestrian activity could include running, walking, hiking, and/or any other suitable activity that may be performed by a pedestrian. In some embodiments, pedestrian activity can be detected from sensor data including GNSS data 103 and/or uncalibrated inertial data 106. The pedestrian activity could be detected by providing any combination of GNSS data 103 and uncalibrated inertial data 106 as input to a machine learning model that is trained to classify movement activity. In some embodiments, the pedestrian activity could be detected by comparing GNSS data 103 and/or uncalibrated inertial data 106 against one or more rules (e.g., thresholds). The pedestrian activity may be detected in response to user input to an electronic device. For example, a walk may be detected in response to a user selecting “walk” in a user interface of a fitness tracking application.

At block 120, global navigation satellite system (GNSS) data and uncalibrated inertial data can be received. One or more of the GNSS data 103 or the uncalibrated inertial data 106 can be received by an electronic device from the device's sensors or memory. The electronic device may begin to record GNSS data 103 or uncalibrated inertial data 106 in response to detecting the pedestrian activity at block 110. For example, the electronic device may begin to perform GNSS techniques after detecting the pedestrian activity using uncalibrated inertial data 106. In some embodiments, the electronic device may increase or decrease a sampling rate for the GNSS data 103 or the uncalibrated inertial data 106 in response to detecting the pedestrian activity.

In some embodiments, one or more of the GNSS data 103 or the uncalibrated inertial data 106 can be received at an electronic device from a companion device. A companion device can be a paired electronic device that is in communication with the electronic device over a short-range communication link (e.g., a Bluetooth connection). The electronic device, or a companion device, can be a wearable electronic device such as a smartwatch.

At block 130, a particular signal environment can be detected. The particular signal environment can be an environment with tall buildings such as a dense urban environment. In some embodiments, the particular environment can be an area with geographic features that would obstruct GNSS signals (e.g., an area with cliffs, mountains, hills, canyons, etc.). The particular signal environment can be detected using GNSS data 103. For example, the global navigation satellite system may provide a map with signal environment information about different geographic areas. The electronic device can use the GNSS data 103 to determine the device's location within this map, and the signal environment information can be used to determine if the electronic device is in the particular signal environment. In some embodiments, the electronic device can determine if it is in the particular signal environment based on an analysis of the GNSS data 103. For example, the electronic device may determine that the device is in the particular signal environment if the GNSS data 103 is sufficiently unstable (e.g., there is a large variance between sequential GNSS location fixes). In some embodiments, the particular signal environment may be detected through user input to a display on the electronic device. The electronic device may present a user interface in response to detecting pedestrian activity, and the interface may prompt the user to answer questions about the environment (e.g., “are you surrounded by tall buildings?”). The device may use this information to detect the particular signal environment.

At block 140, a first calibrated inertial data can be generated using the GNSS data. The first calibrated inertial data can be generated for the duration of the pedestrian activity. Calibrating the inertial data can mean using the GNSS data 103 to bring the uncalibrated inertial data 106 into the GNSS reference frame. Each GNSS location determination in the GNSS data 103 can be a set of coordinates within the GNSS reference frame, but the inertial location determinations in the uncalibrated inertial data 106 are coordinates relative to a starting position. The uncalibrated inertial data 106 can be recorded as coordinates in a session reference frame that is based on the electronic device's position and orientation when the device began recording the uncalibrated inertial odometry data 106. For example, the session reference frame's origin can be the electronic device's starting position, and the axes can be based on the device's starting orientation.

The uncalibrated inertial data 106 can be brought into the GNSS reference frame using GNSS data 103 that is contemporaneous with the inertial data (e.g., two or more location determinations that were generated within a time threshold). This contemporaneous data can be used to determine a correspondence between the GNSS location determinations and inertial location determinations because the data records the same movement along path 109 in both the GNSS reference frame and the session reference frame. To bring the uncalibrated inertial data 106 into the GNSS reference frame, the axes of the session reference frame can be rotated to align with the GNSS reference frame, the uncalibrated inertial data can be transformed so that the inertial/GNSS data are at the same area of the GNSS reference frame, and the units of the session reference frame can be scaled to align with the GNSS reference frame. The uncalibrated inertial data 106 can become first calibrated inertial data 112 after the data is brought into the GNSS reference frame.

At block 150, an operation can be performed with the calibrated inertial data. For example, the first calibrated inertial data 112 can be used to produce metrics or other information about the pedestrian activity. For example, the first calibrated inertial data 112 can be used to calculate the pace that the electronic device is traveling around path 109 and a total distance traveled by the device.

At block 160, a second set of calibrated inertial data can be produced with inlier GNSS data. The second set of calibrated inertial data can be produced after the pedestrian activity has concluded. The inlier GNSS data 121 can be produced by removing or de-weighting outliers 115 from the data. The inlier GNSS data 121 can be used to rotate, transform, and scale the uncalibrated inertial data 106 or the first calibrated inertial data 112.

At block 170, an operation can be performed with the second calibrated inertial data 118. For example, the second calibrated inertial data 118 can be provided to an application such as a fitness tracker. The second calibrated inertial data 118 can be used to calculate any combination of any number of a total distance, pace, and a map for the pedestrian activity. The distance, pace, and map may be calculated during the pedestrian activity and presented to the user on a display. For example, a user of the electronic device may use this information to track a workout or for navigation. The distance, pace, and map may be calculated throughout the pedestrian activity and this information can be displayed to the user in real-time.

Although FIG. 1 shows example blocks of method 101, in some implementations, method 101 may include additional blocks, fewer blocks, different blocks, or differently arranged blocks than those depicted in FIG. 1. Additionally, or alternatively, two or more of the blocks of method 101 may be performed in parallel.

### A. Calibration Architecture

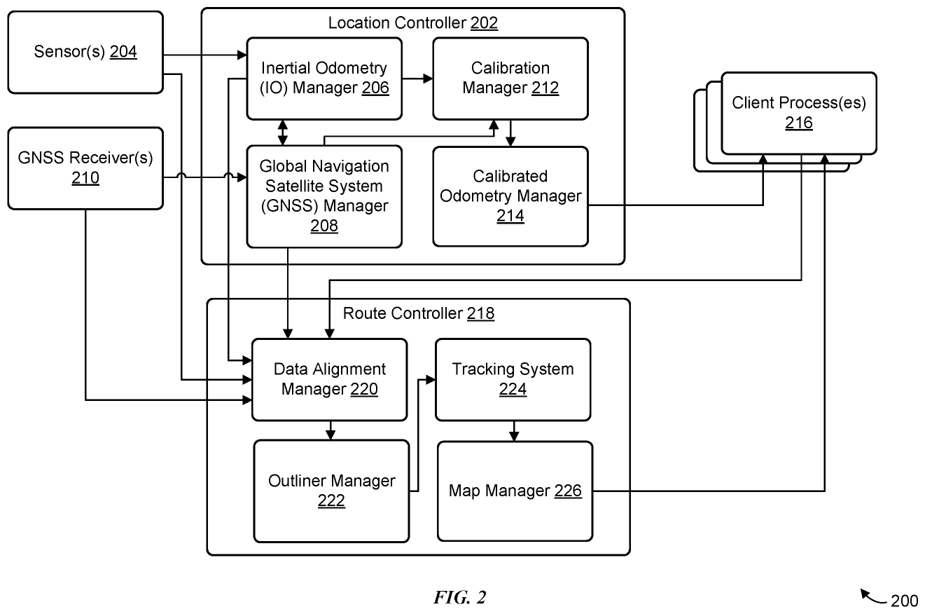

FIG. 2 is a simplified diagram of an architecture 200 for tracking pedestrian activity using calibrated inertial data according to various embodiments. The location controller 202 can receive inertial data from sensor(s) 204 at an inertial odometry (IO) manager 206, and the location controller 202 can receive GNSS data from GNSS receiver(s) 210 at a global navigation satellite system (GNSS) manager 208. Sensor(s) 204 can include any combination of any number of inertial sensors such as accelerometers, magnetometers, and gyroscopes. The GNSS receiver(s) 208 can include one or more antennas for receiving signals from GNSS satellites.

The inertial odometry manager 206 may analyze data from sensor(s) 204 (e.g., sensor data) to detect pedestrian activity of a particular type. The inertial odometry manager 206 may use sensor data as input to a machine learning model that is trained to output a probability that the sensor data corresponds to different types of pedestrian activity. In some embodiments, the inertial odometry manager 206 may compare the sensor data against one or more rules to classify the sensor data as corresponding to different types of pedestrian activity. The different types of pedestrian activity (e.g., the pedestrian activity of a particular type) can include any combination of walking, running, hiking, and climbing stairs.

The inertial odometry manager 206 may use the sensor data to generate inertial data. Each datapoint in the inertial data can be a change in position and orientation relative to a starting position. The GNSS manager 208 may use signal data from the GNSS receiver(s) 210 to generate GNSS data. The signal data can be a pseudorange or distance to one or more satellites in the global navigation satellite system, and the datapoints in the GNSS data can be coordinates on the earth's surface such as longitude and latitude coordinates. The GNSS data may also include an altitude or a height relative to the earth's surface in addition to coordinates on the earth's surface.

Measuring movement with inertial odometry techniques may consume less power than using GNSS techniques. In some embodiments, the inertial odometry manager 206 may detect pedestrian activity using inertial data from the sensor(s) 204. The inertial odometry manager 206 can notify the GNSS manager 208 that pedestrian activity has been detected, and, in response, the GNSS manager 208 may begin to track movement using GNSS receiver(s) 210. In some embodiments, beginning to track movement using GNSS techniques can include initiating GNSS location fixes or changing the rate of GNSS location fixes using data from sensor(s) 204.

The calibration manager 212 can use GNSS data to calibrate inertial data. The GNSS data can be provided to the calibration manager 212 by the GNSS manager 208, and the inertial data can be provided to the calibration manager by the inertial odometry manager 206. The calibration manager can calibrate the inertial data by bringing the inertial data and the GNSS data into a common reference frame. The inertial data may be brought into the GNSS reference frame, or both the inertial data and the GNSS data can be brought into a new reference frame.

The calibration manager 212 can bring the inertial data into the GNSS reference frame by translating, rotating, and scaling the inertial data. The inertial data and the GNSS data can each be represented as separate matrixes using the following formulas:

$$[ \begin{matrix}{x}_{1} & {y}_{1} & {z}_{1} \\ {x}_{2} & {y}_{2} & {z}_{2} \\ ⋮ & ⋮ & ⋮ \\ {x}_{N} & {y}_{N} & {z}_{N}\end{matrix} ] = GNSS$$

$$[ \begin{matrix}{x}_{1}^{′} & {y}_{1}^{′} & {z}_{1}^{′} \\ {x}_{2}^{′} & {y}_{2}^{′} & {z}_{2}^{′} \\ ⋮ & ⋮ & ⋮ \\ {x}_{N}^{′} & {y}_{N}^{′} & {z}_{N}^{′}\end{matrix} ] = IO$$

Where each row represents a three-dimensional coordinate for a datapoint a dataset. GNSS can represent the GNSS data, “x” can represent the datapoint's x coordinate in the GNSS reference frame, “y” can represent the datapoint's y coordinate in the GNSS frame, and “z” can represent the datapoint's z coordinate in the GNSS reference frame. IO can represent the inertial data, “x” can represent the datapoint's x coordinate in the inertial reference frame, “y” can represent the datapoint's y coordinate in the inertial frame, and “z” can represent the datapoint's z coordinate in the inertial reference frame. “N” can be the number of observations in a dataset.

Translating the inertial data can mean determining a correspondence between the coordinates in the inertial reference frame and coordinates in the GNSS reference frame. The correspondence can be determined by calculating the coordinates of a centroid for each matrix. The coordinates for the centroids of each dataset are given by the following formula:

$${μ}_{GNSS} = \frac{1}{n} {\sum }_{i = 1}^{n} {gnss}_{i}$$

$${μ}_{IO} = \frac{1}{n} {\sum }_{i = 1}^{n} {io}_{i}$$

Where μ_{GNSS} is the centroid of the GNSS data, n is the number of datapoints in the GNSS data, and gnssᵢ is a three-dimensional coordinate for a datapoint in the GNSS data (e.g., a row in the GNSS matrix). μ_{IO} is the centroid of the inertial data, n is the number of datapoints in the inertial data, and ioᵢ is a three-dimensional coordinate for a datapoint in the inertial data (e.g., a row in the IO matrix). The inertial data can be transformed by subtracting the centroid of the inertial data (μ_{IO}) from each datapoint in the inertial data (e.g., each row in the IO matrix), and adding the centroid of the GNSS data (μ_{GNSS}) to each datapoint in the inertial data. The centroids may be assigned weights in some embodiments, and the weights may be initialized with the horizontal uncertainty for the data. A weighted centroid formula is shown in the following pseudocode:
% centroid of the given observations

centroidRef=w′*ref;

centroidIn=w′*in;

Where ref is data from a reference path, in is uncalibrated inertial data, and w represents normalized weights.

The calibration manager 212 can use a covariance matrix to rotate the inertial data so that the inertial data aligns with the GNSS data. The covariance matrix can be calculated using the following formula:

$$H = \frac{1}{n} {\sum }_{i = 1}^{n} {( {io}_{i} - {μ}_{IO} )}^{T} ( {gnss}_{i} - {μ}_{GNSS} )$$

Where H is the covariance matrix, n is the number of datapoints in the datasets, gnssᵢ is a three-dimensional coordinate for a datapoint in the GNSS data, ioᵢ is a three-dimensional coordinate for a datapoint in the inertial data, μ_{GNSS} is the centroid of the GNSS data, and μ_{IO} is the centroid of the inertial data.

In addition or alternatively, a covariance matrix (e.g., “H”) formulation with weights is shown in the following pseudocode:

W=diag(w); % diagonal normalized weight matrix

H=refAtOrigin′*W*inAtOrigin;

%(refAtOrigin′*inAtOrigin)/m;
% m is number of observation e.g., number of rows

The calibration manager 212 can determine a rotation matrix by taking the singular value decomposition of the covariance matrix. The single value decomposition is given by the following formula:

H=UDV^{T}

Where H is the covariance matrix, U and V are orthogonal matrixes, and D is a diagonal matrix. U contains the left singular vectors of H, V contains the right singular vectors of H, and D is the singular values of H.

The rotation matrix can be determined using the following formula:

R=USV^{T}

Where R is the rotation matrix, and S is given by the following formula:

$$S = ( \begin{matrix}1 & 0 & 0 \\ 0 & 1 & 0 \\ 0 & 0 & d\end{matrix} )$$

Where “d” is given by the following formula:

d=det(UV^{T})

The calibration manager 212 can scale the rotated inertial data with the variance of the inertial data. The variance of the inertial data can be calculated using the following formula:

$${σ}_{IO}^{2} = \frac{1}{n} {\sum }_{i = 1}^{n} {‖ {io}_{i} - {μ}_{IO} ‖}^{2}$$

Where

$${σ}_{IO}^{2}$$

is the variance of the inertial dataset, n is the number of observations in the inertial dataset, IOᵢ is a datapoint in the inertial dataset, and μ_{IO} is the centroid of the inertial dataset. In addition or alternatively, the variance formula may be used with a weighted sigma Σ as shown in the following pseudocode:

sigmaRef=w′*vecnorm(refAtOrigin,2,2).\hat{ }2

The calibration manager 212 can calculate the scaling factor for the inertial data using the following formula:

$$c = \frac{{σ}_{IO}^{2}}{tr ( DS )}$$

Where c is the scaling factor,

$${σ}_{IO}^{2}$$

is the variance for the dataset, and the denominator is the trace of the sum of the matrix D and the matrix S. The calibration manager 212 can represent a datapoint from the inertial data as a coordinate in the GNSS reference frame using the following formula:

[symbol]

=μ_{GNSS}+CR(ioᵢ−μ_{B})

Where, [symbol] ᵢ is a three-dimensional coordinate for an inertial datapoint in the GNSS reference frame, μ_{GNSS} is the centroid of the GNSS data in the GNSS reference frame, c is the scaling factor, 10; is the inertial datapoint in the inertial reference frame, and μ_{B} is the centroid of the inertial data in the inertial reference frame. The scaling factor can be a three-dimensional scaling factor and the scaling factor for each axis can be a different scaling factor. Calibrated inertial data can be inertial data that is transformed, rotated, and scaled (e.g., brought into the GNSS reference frame).

The calibration manager 212 can generate the calibrated inertial data by finding the rotation, transformation, and scaling that minimizes the root mean square difference between the GNSS data and the inertial data in the GNSS reference frame. The root mean square deviation can be given by the following formula:

$$RMSD ( {\hat{io}}_{i} , {gnss}_{i} ) = \sqrt{\frac{1}{n} {\sum }_{i}^{n} {\vert {\hat{io}}_{i} - {gnss}_{i} \vert}^{2}}$$

Where the RMSD is the root mean square deviation, [symbol] ᵢ is an inertial datapoint in the GNSS reference frame, gnss; is a GNSS datapoint, and “n” is the total number of datapoints in the set of inertial data. The calibrated inertial data can be found by calculating the RMSD for inertial data with different combinations of rotations, transformations, and scales. The calibrated inertial data can be inertial data with a rotation, transformation, and scale that minimizes the RMSD for the dataset.

The calibration manager 212 can recalibrate the inertial data at regular intervals (e.g., every 1 second), or in response to an event. For example, the inertial data can be recalibrated when a new inertial datapoint is received or when a threshold number of inertial datapoints are received. The calibration manager 212 may use the calibrated inertial data to remove outlier datapoints from the GNSS data. Any of the operations of the calibration manager 212 can be performed by the outlier manager 222, and any of the operations of the outlier manager 222 can be performed by the calibration manager 212.

The calibrated inertial data can be provided to the calibrated odometry manager 214 by the calibration manager 212. The calibrated odometry manager 214 can calculate various metrics for pedestrian activity using the calibrated inertial data. The metrics can include a distance and/or a pace. The distance can be an estimate of the total displacement of the electronic device that recorded the inertial data, and the pace can be a rate of displacement of the electronic device.

The metrics can be provided to client processes 216 by the calibrated odometry manager. The client processes 216 may include applications executing on an electronic device that is implementing the location controller 202. For example, the client processes 216 can include a mapping application, a fitness tracking application, a journaling application, a device tracking application (e.g., to find lost devices), or system processes of the electronic device.

The route controller 218 can include a data alignment manager 220. The data alignment manager 220 can access inertial data from the inertial odometry manager 206, and GNSS data from the GNSS manager 208. In various embodiments, the data alignment manager 220 can generate inertial data from sensor data that is accessed from the sensor(s) 204, and the data alignment manager 220 can generate GNSS data from signal data that is accessed from the GNSS Receiver(s) 210. The inertial data, the GNSS data, the sensor data, and/or the signal data can be accessed from client process(es) 216 by the data alignment manager 220. The data alignment manager 220 may temporally align the inertial data and the GNSS data. Temporally aligning the inertial data and the GNSS data can mean matching a datapoint from the GNSS data with a contemporaneous datapoint from the inertial data. Datapoints can be contemporaneous if they were produced at the same time (or within a threshold amount of time).

The outlier manager 222 can use inertial data to remove outliers from the GNSS data. The outlier manager can use uncalibrated inertial data to exclude outliers from the GNSS data. The outlier manager can remove outliers by assigning weights to each pair of datapoints produced by the data alignment manager 220 using the following formula:

$$WRMSD ( {\hat{io}}_{i} , {gnss}_{i} ) = \sqrt{\frac{{\sum }_{i}^{n} {w}_{i} {\vert {\hat{io}}_{i} - {gnss}_{i} \vert}^{2}}{{\sum }_{i - 1}^{n} {w}_{i}}}$$

Where the WRMSD is the weighted root mean square deviation, [symbol] ᵢ is an inertial datapoint in the GNSS reference frame, gnssᵢ is a GNSS datapoint, “n” is the total number of datapoints in the set of inertial data, and wᵢ is a weight for the pair of datapoints. The calibrated inertial data can be found by calculating the WRMSD for inertial data with different combinations of rotations, transformations, scales, and weights. The calibrated inlier inertial data can be inertial data with a rotation, transformation, scale, and weight that minimizes the WRMSD for the dataset. The RMSD for an inertial datapoint and an outlier GNSS datapoint is likely large because the coordinates of the outlier GNSS datapoint is likely to be far from the coordinates of the inertial datapoint. The outlier GNSS datapoint may be the result of a signal error, and varying the rotation, transformation, and scale is not likely to minimize the RMSD between the outlier GNSS datapoint and a corresponding inertial datapoint without increasing the RMSD for other pairs of datapoints. Instead, minimizing the WRMSD likely involves determining a rotation, transformation, and scale that works for the majority of datapoint pairs, and assigning a small weight to outlier datapoint pairs.

In addition or alternatively, calibrated inertial data can be calculated using weights as shown in the following pseudocode:

```
  function [isSuccessful, out] = runRobustUmeyama(ioTraj, gnssTraj, initialWeight)
    ioTraj_Calibrated = Umeyama(ioTraj gnssTraj, initialWeight);
    for iter = 1:obj.maxIteration
      % compute residuals which are distance between reference data and calibrated io data
      residuals = vecnorm(ioTraj_alignedScaledTraslated − gnssTraj,);
      % compute and update weights based on residuals
      weights = huberNorm(residuals);
      % run Umeyama with updated weights
      ioTraj_Calibrated_Updated = Umeyama(ioTraj, gnssTraj, weights);
      % check convergence (if calibration change is below threshold)
      changeInCalibration = mean(vecnorm(ioTraj_Calibrated − ioTraj_Calibrated_Updated,
2, 2));
      if changeInCalibration < convergenceThreshold
        end
        break;
      end
      ioTraj_Calibrated = ioTraj_Calibrated_Updated;
    end.
```

Where ioTraj is the uncalibrated inertial odometry dataset, gnssTraj is the GNSS dataset with inliers and outliers, ioTraj_Calibrated and ioTraj_alignedScaledTraslated are the calibrated inertial odometry datasets, vecnorm is a function that returns the norm (e.g., the magnitude) of a vector, huberNorm is a loss function that outputs a difference between estimated values and observed values, and Umeyama is a function that calls a weighted Umeyama algorithm (e.g., using the Umeyama algorithm with the weighted covariance matrix, weighted centroids, and weighted sigma values shown above). More details about the Umeyama algorithm can be found at the following paper which is incorporated for all purposes: Lawrence, Jim, Javier Bernal, and Christoph Witzgall. “A purely algebraic justification of the Kabsch-Umeyama algorithm.” Journal of research of the National Institute of Standards and Technology 124 (2019): 1.

The outlier manager 222 can provide the calibrated inertial data to the tracking system 224. The tracking system 224 can fuse the calibrated inertial data and the GNSS data to estimate a path for the electronic device's movement during the pedestrian activity. The tracking system 224 can use a Rauch-Tung-Striebel (RTS) smoother to fuse the calibrated inertial data and the GNSS data. The calibrated inertial data can be a series of discrete coordinates, and the tracking system 224 can use these points to estimate a continuous path from the calibrated inertial data. More details about the Rauch-Tung-Striebel (RTS) smoother can be found at the following paper which is incorporated for all purposes: van Der Laan, Niels, et al. “The invariant rauch-tung-striebel smoother.” IEEE Robotics and Automation Letters 5.4 (2020): 5067-5074.

The map manager 226 can match the estimated path from the tracking system 224 to paths in map data. The map data may include paths such as roads or walking paths, and the map manager 226 can identify paths in the map data that correspond to the estimated path. The map manager 226 can revise the estimated path by using the map data. For example, the coordinates in the estimated path can be averaged with the coordinates of a matching path, or some or all of the coordinates in the estimated path can be replaced by coordinates of the matching path. The revised path can be provided to the client processes 216 by the map manager 226.

### B. Calibration Examples

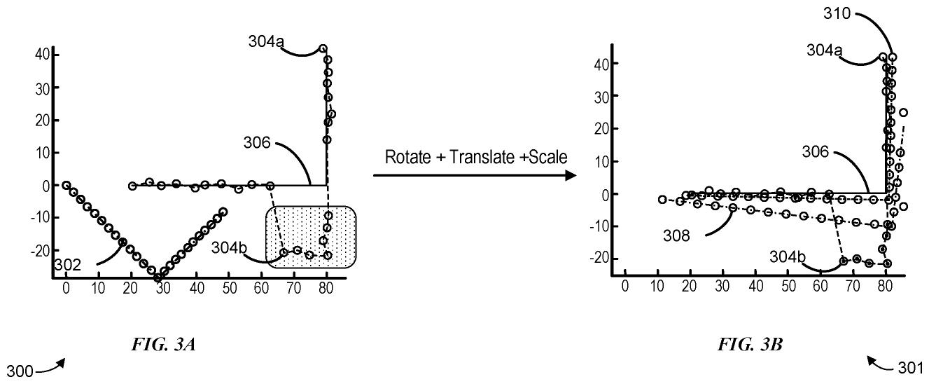

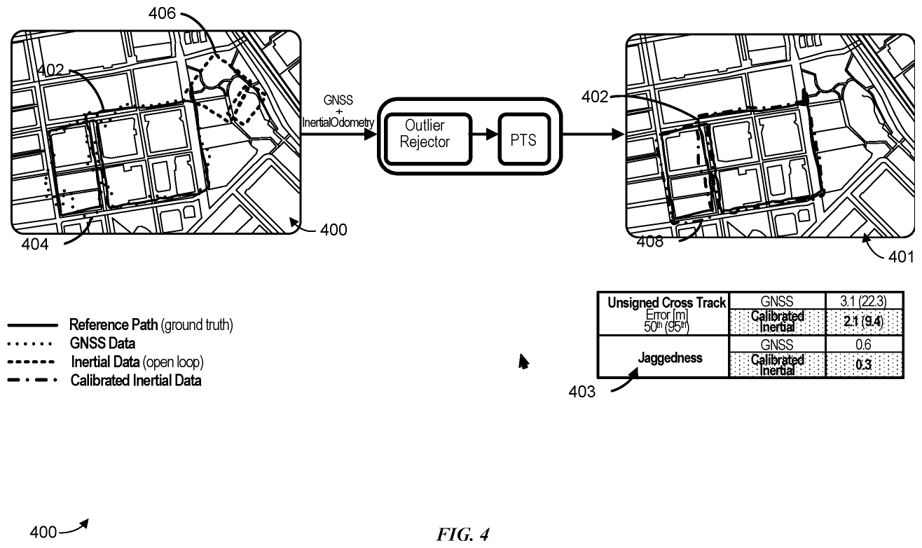

FIGS. 3A-3B are graphs 300-301 showing comparisons between GNSS data and raw inertial data according to various embodiments. The x and y axes of the graphs shown in FIGS. 3A-3B can be position coordinates in meters. Turning now to FIG. 3A in greater detail, the uncalibrated inertial data 302 and the GNSS data 304a-304b can be generated by an electronic device as the device travels along reference path 306. The reference path 306 can be the ground truth that represents the actual path taken by the electronic device. The shape of the uncalibrated inertial data 302 is similar to the shape of the reference path, but the uncalibrated inertial data 302 is rotated and offset from the reference path 306. The uncalibrated inertial data 302 has a different scale than the reference path 306 and the reference path 306 is larger than the uncalibrated inertial data 302.

The GNSS data 304a-304b includes inlier GNSS data 304a and outlier GNSS data 304b. The inlier GNSS data 304a aligns with the reference path 306 and the inlier data has the same scale and rotation as the reference path 306. However, the outlier GNSS data 304b is offset from the reference path 306.

Turning now to FIG. 3B, the uncalibrated inertial data 302 can be calibrated using the GNSS data 304a-304b. The first calibrated inertial data 308 can be produced by rotating, translating, and scaling the inertial data 302 using both the inlier GNSS data 304a and the outlier GNSS data 304b. The first calibrated inertial data 308 more closely align with the reference path 306 than the uncalibrated inertial data 302, but the first calibrated inertial data 308 is offset from the reference path 306 because of the influence of the outlier GNSS data 304b. The second calibrated inertial data 310 can be generated using the uncalibrated inertial data 302 and the inlier GNSS data 304a but not the outlier GNSS data 304b. The second calibrated GNSS data 310 better approximates the orientation and scale of the reference path 306 than the first calibrated GNSS data 308.

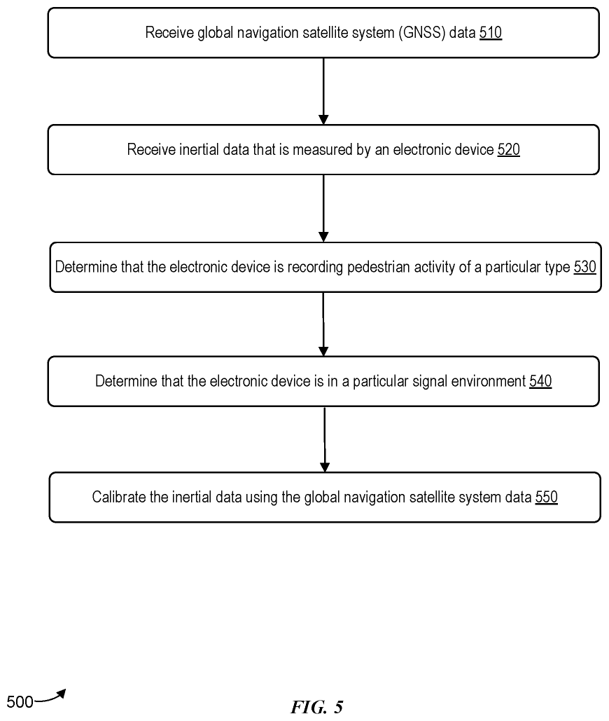

FIG. 4 shows simplified maps 400-401 with inertial data according to various embodiments. Map 400 displays inertial data before calibration. The map 400 includers a reference path 402, GNSS data 404, and uncalibrated inertial data 406. Neither of the GNSS data 404 or the uncalibrated inertial data 406 closely matches the reference path 402. The GNSS data 404 is erratic and the data does not match the shape of the reference path 402. The uncalibrated inertial data 406 has a similar shape to the reference path 402, but the uncalibrated data is rotated and offset from the reference path 402. In addition, the uncalibrated inertial data 406 is smaller than the reference path 402.

Map 401 shows the inertial data after calibration, and the map includes the reference path 402 and calibrated inertial data 408. The calibrated inertial data 408 more accurately replicates the reference path 402 than the GNSS data 404 or the uncalibrated inertial data 406. The calibrated inertial data 408 has a similar shape, location, and size to the reference path 402.

Table 403 compares the unsigned cross track error and the jaggedness of the GNSS data 404 and the calibrated inertial data 408. Unsigned cross track error is the deviation from the reference path 402 in meters. The 50th and 90th percentiles for the unsigned cross track error can be calculated for each dataset, and the percentiles can be averaged across datasets. For example, any of a mean, median, and mode of the 50th percentile unsigned cross track error can be calculated. Jaggedness indicates the smoothness of the trajectory for a given session, and a single jaggedness can be computed for each session. The jaggedness can be computed based on deviation of the cross track error normalized by total distance traveled. Smaller jaggedness and unsigned cross track error values can indicate better performance than larger values. The unsigned cross track error can be calculated using the following formula:

diffOfCrossTrackError=abs(diff(CrossTrackError));

Where diffOfCrossTrackError is the unsigned cross track error for a dataset, and abs(diff(CrossTrackError) is the absolute value of the cross track error for the dataset.

Jaggedness can be given with the following formula:

jaggedness=sum(diffOfCrossTrackError)/trueTotalDistanceTravelled;

Where sum (diffOfCrossTrackError) is the sum of the cross track error across datasets that were generated during a session and trueTotalDistanceTravelled is the actual distance traveled during the session.

### C. Calibration Flow

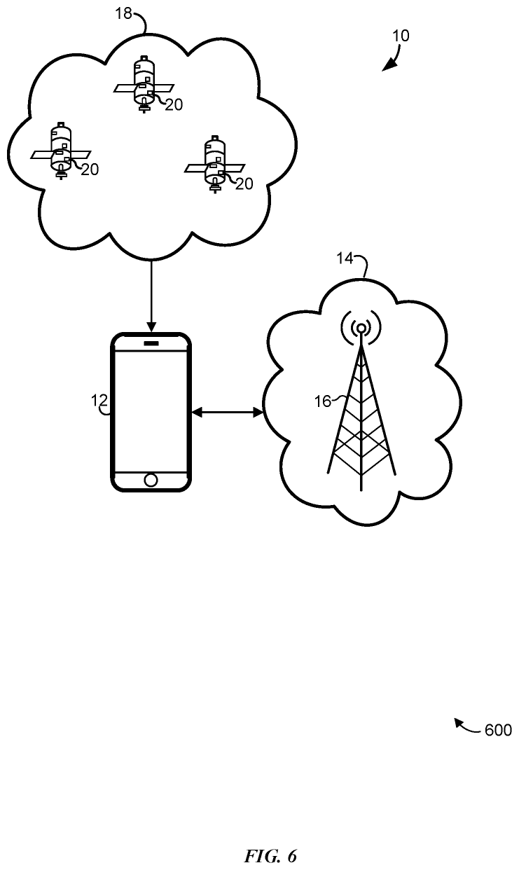

FIG. 5 is a flowchart illustrating a method 500 for calibrating inertial data according to various embodiments. In some implementations, one or more method blocks of FIG. 5 may be performed by a mobile device (e.g., user equipment 12, architecture 900, electronic device 1000). In some implementations, one or more method blocks of FIG. 5 may be performed by another device or a group of devices separate from or including the mobile device. Additionally, or alternatively, one or more method blocks of FIG. 5 may be performed by one or more components of the mobile device, such as processor 22, memory 24, nonvolatile storage 26, input structures 30, network interface 34, sensors 37, GNSS receiver 48, antenna 50, application processor 905, receiver 910, antenna 925a-925n, location manager 935, input components 950, wireless circuitry 965, auxiliary processor 970, inertial sensor(s) 980, processor 1018, computer-readable medium 1002, Input/Output (I/O) subsystem 1006, wireless circuitry 1008, etc.

Turning to FIG. 5 in greater detail, at block 510, global navigation satellite system (GNSS) data can be received. The GNSS data can be received at various frequencies including 0.001 Hertz (Hz), 0.01 Hz, 0.1 Hz, 0.5 Hz, 1 Hz, 2 Hz, 5 Hz, and 10 Hz. In some embodiments, the GNSS data may be received at a first frequency before the pedestrian activity is detected, and the data may be received at a second frequency after the pedestrian activity is detected. In some embodiments, the GNSS data may not be received until the pedestrian activity is detected using inertial data.

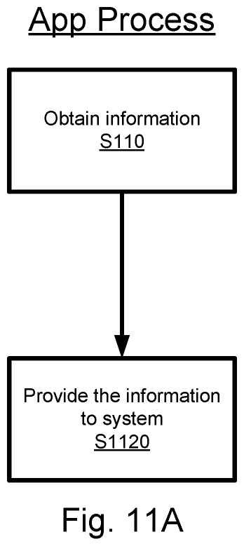

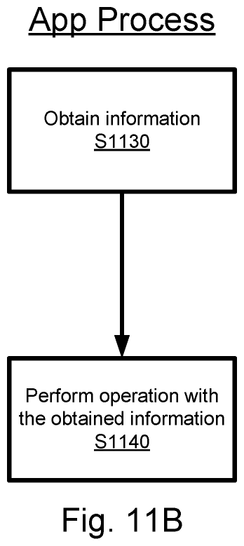

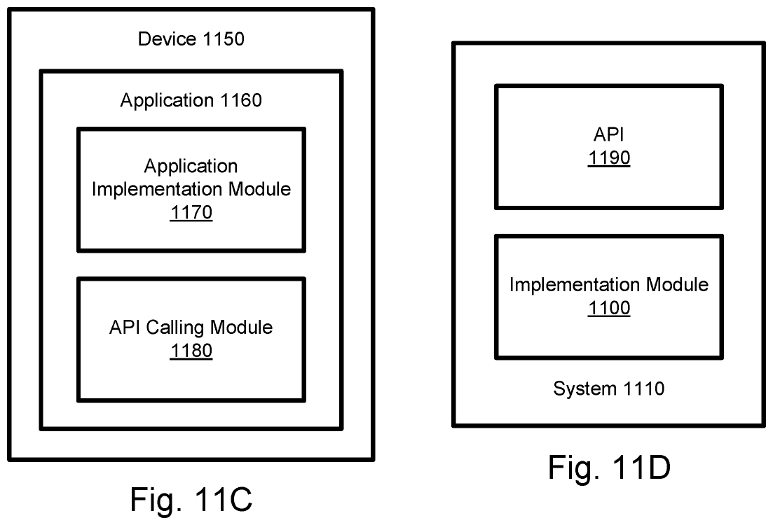

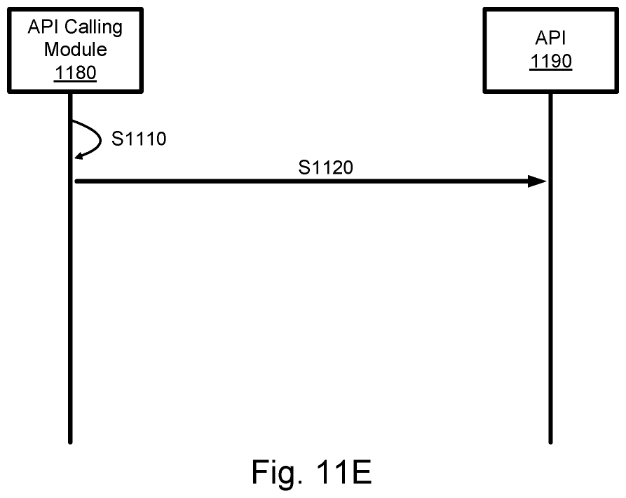

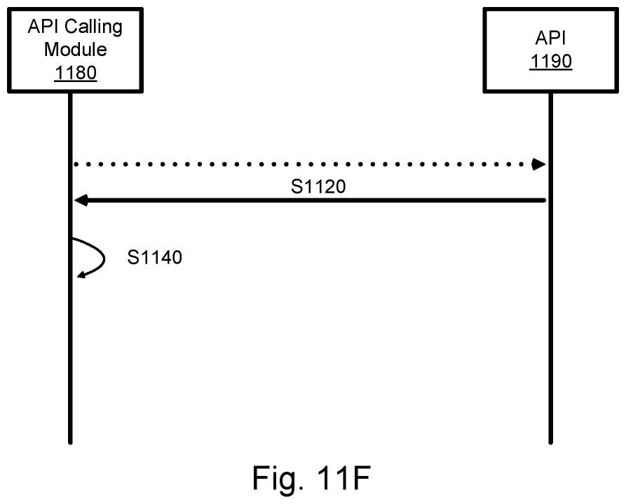

The GNSS data may be received at an electronic device from a companion device. For example, the electronic device can be a wearable electronic device such as a smartwatch, and the GNSS data may be received over a communication link from a paired mobile device. A companion device to a first electronic device can be a second electronic device that is paired with the first electronic device, and the first electronic device can communicate with the companion device over a communication link that is implemented with a short-range communication protocol (e.g., Bluetooth, Bluetooth low energy (BLE), or WiFi). A companion device and an electronic device may be collocated (e.g., within a threshold distance of the same location). Any of the operations of method 500 can be performed on the first electronic device or the companion device, and the devices may communicate using an application programming interface (API) as described below with reference to FIGS. 11A-11F.

Receiving the GNSS data can include determining one or more GNSS signal conditions. The signal conditions can include any combination of any number of a GNSS signal strength, an elevation of the electronic device at the time that the GNSS signal is measured, an azimuth, and a multipath indicator. An azimuth can be an angle between a reference direction (e.g., a cardinal direction) and a point on the same plane as the reference direction, and a multipath indicator can be. The particular signal environment can be determined using the one or more GNSS signal conditions. For example, one or more of the GNSS signal conditions can be compared against corresponding thresholds.

At block 520, inertial data that is measured by an electronic device can be received. The inertial data can be measured by an electronic device that is implementing method 500, or the inertial data can be received from a companion device that measures the inertial data. In some embodiments, the inertial data can be measured at a first rate before the pedestrian activity is detected, and the inertial data can be measured at a second rate after the pedestrian activity is detected. The first rate can be higher or lower than the second rate. The inertial data may be measured in response to detecting the pedestrian activity using GNSS data.

At block 530, that the electronic device is recording pedestrian activity of a particular type can be determined. The particular type can be a walk, a run, or a hike in various embodiments. The pedestrian activity may be detected using any combination of the inertial data and the GNSS data. The pedestrian activity of a particular type may be detected by providing one or more of the GNSS data and the inertial data as input to a machine learning model that is trained to classify movement. In some embodiments, the pedestrian activity of a particular type can be detected by comparing any combination of the GNSS data and the inertial data against one or more rules.

Determining that the electronic device is recording pedestrian activity of a particular type can include determining a carrying type and/or a gait type for the pedestrian activity. For example, the carrying type for a smartwatch could be whether the electronic device is being worn on the left wrist or the right wrist. The carrying type for a mobile device could be that the device is held in the right hand, the left hand, a front right pants pocket, a front left pants pocket, a back left pants pocket, a back right pants pocket, mounted on the left upper arm, or mounted on the right upper arm. The gait type can include one or more of walking, stair climbing, and running.

At block 540, that the electronic device is in a particular signal environment can be determined. The particular signal environment can be a congested signal environment in some embodiments. The particular signal environment can be a dense urban environment, a tunnel, or a canyon in various embodiments. In some embodiments, the particular signal environment can be detected using GNSS data. The global navigation satellite system may provide signal environment information for one or more regions (e.g., tiles) of a map, and the particular signal environment can be detected by locating the signal environment information that corresponds to a GNSS location determination (e.g., a GNSS fix). The electronic device may begin to record inertial data in response to determining that the device is in the particular signal environment. In some embodiments, the particular signal environment can be detected by determining that the variance between GNSS location determinations is above a threshold (e.g., the GNSS data is unstable). Any distance threshold described in this disclosure can be 1 meter (m), 2 m, 3 m, 5 m, 10 m, 15 m, 20 m, 30 m, 40 m, 50 m, 75 m, 100 m, 150 m, 200 m, and 300 m.

Determining that the electronic device is in the particular signal environment can include determining a tile in a map that corresponds to the global navigation satellite system data. The tile can be used to access signal environment information that corresponds to the geographic region that is represented by the tile. The signal environment information can be used to determine that the electronic device is in the particular signal environment.

At block 550, the inertial data can be calibrated using the global navigation satellite system data to generate calibrated movement data. The inertial data can be calibrated in response to determining that the electronic device is recording pedestrian activity of a particular type in the particular signal environment. Generating the calibrated movement data can further comprise removing outliers from the global navigation satellite system data using the calibrated inertial data. The calibrated movement data can be used to calculate a distance and a pace for the pedestrian activity. In some embodiments, a path of the pedestrian activity can be displayed on the map using the calibrated movement data.

The calibrated inertial data can be used to perform one or more operations. For example, the calibrated inertial data can be provided to an application such as a fitness tracking application. The calibrated inertial data can be used to calculate one or more metrics about the pedestrian activity. The metrics can include one or more paces or one or more distances for the pedestrian activity. The operations can include displaying a path that corresponds to the calibrated inertial data on a map.

Method 500 may include additional implementations, such as any single implementation or any combination of implementations described below and/or in connection with one or more other processes described elsewhere herein.

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel.

### II. Global Navigation Satellite System

A mobile device can communicate with satellites of a global navigation satellite system (GNSS) to determine the device's location. GNSS navigation may begin with a signal acquisition stage where the mobile device establishes communication with available GNSS satellites. Once the satellites are acquired, the mobile device can exchange ranging messages with these satellites to determine the device's location.

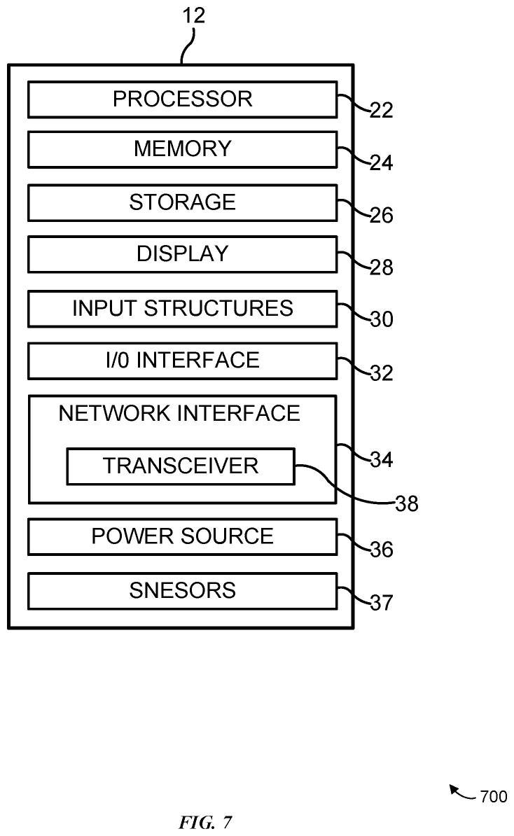

FIG. 6 is a schematic diagram of a communication system 10 having user equipment 12 communicatively coupled to a cellular network 14 (e.g., a third generation (3G) cellular network, a fourth generation (4G) or Long Term Evolution (LTE) cellular network, a fifth generation (5G) or New Radio (NR) cellular network, a beyond 5G cellular network, or the like) via a cellular base station 16 (e.g., a NodeB, an eNodeB, a gNodeB, or the like), and communicatively coupled to a GNSS network 18 via one or more GNSS satellites 20, accordingly to embodiments of the present disclosure. The cellular network 14 may be implemented and/or supported by multiple such base stations 16, radio access networks, core networks, and so on. Similarly, the GNSS network 18 may be implemented and/or supported by multiple such GNSS satellites 20, ground stations, and so on. Although certain embodiments are described herein with respect to processing a GNSS signal from one or more GNSS satellites 20, it should be understood that in other embodiments, the user equipment 12 may be communicatively coupled to a GPS network in addition to, or instead of, the GNSS network 18 via one or more GPS satellites and process a GPS signal from the GPS satellites in accordance with embodiments described herein.

The user equipment 12 may receive signals from the GNSS satellites 20 and process the signals to determine a global position of the user equipment 12. In particular, each GNSS satellite 20 may transmit one or more pilot channels alongside a data signal. Each pilot channel is a dataless signal transmitted from a corresponding GNSS satellite 20. The user equipment 12 may process one or more of the pilot channels from one or more GNSS satellites 20 to determine the position of the user equipment 12. In certain embodiments, the user equipment 12 may generate and maintain respective tracking loops for each pilot channel received from the GNSS satellites 20. For instance, the user equipment 12 may receive a single pilot channel from a GNSS satellite 20, two pilot channels from a GNSS satellite 20, three pilot channels from a GNSS satellite 20, four pilot channels from a GNSS satellite 20, five pilot channels or more from a GNSS satellite 20, and so on. Additionally, the user equipment 12 may receive pilot channels from more than one GNSS satellite 20 (e.g., up to thirty-five or more satellites).

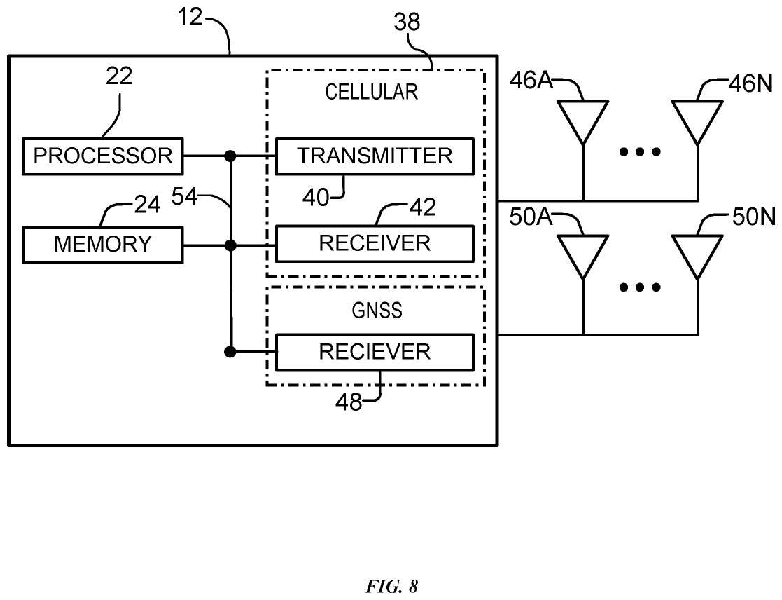

FIG. 7 is a block diagram of the user equipment 12 (e.g., an electronic device) of FIG. 6, according to embodiments of the present disclosure. The user equipment 12 may include, among other things, one or more processors 22 (collectively referred to herein as a single processor for convenience, which may be implemented in any suitable form of processing circuitry), memory 24, nonvolatile storage 26, a display 28, input structures 30, an Input/Output (I/O) interface 32, a network interface 34, a power source 36, and one or more sensors 37. The various functional blocks shown in FIG. 7 may include hardware elements (including circuitry), software elements (including machine-executable instructions) or a combination of both hardware and software elements (which may be referred to as logic). The processor 22, the memory 24, the nonvolatile storage 26, the display 28, the input structures 30, the I/O interface 32, the network interface 34, the power source 36, and/or the sensors 37 may each be communicatively coupled directly or indirectly (e.g., through or via another component, a communication bus, a network) to one another to transmit and/or receive data between one another. It should be noted that FIG. 7 is merely one example of a particular implementation and is intended to illustrate the types of components that may be present in the user equipment 12.

By way of example, the user equipment 12 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple, Inc. of Cupertino, California), a wearable electronic device (e.g., in the form of an Apple Watch® by Apple Inc. of Cupertino, California), and other similar devices. It should be noted that the processor 22 and other related items in FIG. 7 may be generally referred to herein as “data processing circuitry.” Such data processing circuitry may be embodied wholly or in part as software, hardware, or both. Furthermore, the processor 22 and other related items in FIG. 2 may be a single contained processing module or may be incorporated wholly or partially within any of the other elements within the user equipment 12. The processor 22 may be implemented with any combination of general purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processor 22 may include one or more application processors, one or more baseband processors, one or more auxiliary processors, or any combination thereof, and perform the various functions described herein.

In the user equipment 12 of FIG. 7, the processor 22 may be operably coupled with a memory 24 and a nonvolatile storage 26 to perform various algorithms. Such programs or instructions executed by the processor 22 may be stored in any suitable article of manufacture that includes one or more tangible, computer-readable media. The tangible, computer-readable media may include the memory 24 and/or the nonvolatile storage 26, individually or collectively, to store the instructions or routines. The memory 24 and the nonvolatile storage 26 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 22 to enable the user equipment 12 to provide various functionalities.

In certain embodiments, the display 28 may facilitate users to view images generated on the user equipment 12. In some embodiments, the display 28 may include a touch screen, which may facilitate user interaction with a user interface of the user equipment 12. Furthermore, it should be appreciated that, in some embodiments, the display 28 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 30 of the user equipment 12 may enable a user to interact with the user equipment 12 (e.g., pressing a button to increase or decrease a volume level). The I/O interface 32 may enable user equipment 12 to interface with various other electronic devices, as may the network interface 34. In some embodiments, the I/O interface 32 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 34 may include, for example, one or more interfaces for a personal area network (PAN), such as an ultra-wideband (UWB) or a BLUETOOTH® network, for a local area network (LAN) or wireless local area network (WLAN), such as a network employing one of the IEEE 902.11x family of protocols (e.g., WI-FI®), and/or a wide area network (WAN), such as any standards related to the Third Generation Partnership Project (3GPP), including, for example, a third generation (3G) cellular network, a universal mobile telecommunication system (UMTS), a fourth generation (4G) cellular network, a long term evolution (LTE®) cellular network, a long term evolution licenses assisted access (LTELAA) cellular network, a fifth generation (5G) cellular network, New Radio (NR) cellular network, a cellular network beyond 5G, a satellite network, and so on. In particular, the network interface 34 may include, for example, one or more interfaces for using a Release-15 cellular communication standard of the 5G specifications that include the millimeter (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 34 of the user equipment 12 may allow communication over the aforementioned networks (e.g., 5G, Wi-Fi, LTE-LAA, and so forth).

The network interface 34 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 34 includes a transceiver 38. In some embodiments, all or portions of the transceiver 38 may be disposed within the processor 22. The transceiver 38 may support transmission and receipt of various wireless signals via one or more antennas, and thus may include a transmitter and a receiver. The power source 36 of the user equipment 12 may include any suitable source of power, such as a rechargeable lithium polymer (Li-poly) battery and/or an alternating (AC) power converter.

The sensors 37 of the user equipment 12 may include one or more motion sensors, one or more temperature sensors, one or more light sensors, one or more pressure sensors, one or more cameras or image sensors, or any other suitable sensors. In certain embodiments, the motion sensors may include an inertial measurement unit (IMU), a three-dimensional accelerometer, a three-dimensional gyroscope, or the like, that may detect a motion of the user equipment 12. For example, the IMU may detect a rotation of the user equipment 12, a rotational movement of the user equipment 12, an angular displacement of the user equipment 12, a tilt of the user equipment 12, an orientation of the user equipment 12, a linear motion of the user equipment 12, a non-linear motion of the user equipment 12, or the like. The temperature sensors may include a temperature sensor that may measure a temperature of an oscillator of a GNSS receiver of the user equipment 12, an internal temperature of the user equipment 12, a circuit junction temperature of the user equipment 12, an external temperature of the user equipment 12, or the like. Temperature measurements from the temperature sensors can be provided as input to a thermal arbiter executing on processor 22. The light sensors may detect a quantity of ambient light external to the user equipment 12. The pressure sensors may include, for example, a barometer, that may detect an atmospheric pressure associated with the user equipment 12. The sensors 37 may additionally or alternatively include one or more cameras, such as onboard cameras for visual inertial odometry and/or other suitable position/location sensing techniques.

FIG. 8 is a functional diagram of the user equipment 12 of FIGS. 6 and 7, according to embodiments of the present disclosure. As illustrated, the processor 22, the memory 24, the transceiver 38, a transmitter 40, a receiver 42, antennas 46 (illustrated as 46A-46N, collectively referred to as an antenna 46), and/or a GNSS receiver 48 may be communicatively coupled directly or indirectly (e.g., through or via another component, a communication bus, a network) to one another to transmit and/or receive data between one another.

In particular, the transceiver 38 may be in the form of a cellular transceiver 38 having a cellular transmitter 40 and/or a cellular receiver 42 that respectively enable transmission and reception of cellular signals between the user equipment 12 and an external device via, for example, a cellular network (e.g., including base stations, such as NodeBs, eNBs or eNodeBs (Evolved NodeBs or E-UTRAN (Evolved Universal Mobile Telecommunication System (UMTS) Terrestrial Radio Access Network) NodeBs, or gNBs or gNodeBs (e.g., Next Generation NodeB))). As illustrated, the cellular transmitter 40 and the cellular receiver 42 may be combined into the cellular transceiver 38.

Additionally, the user equipment 12 may also include the GNSS receiver 48 that may enable the user equipment 12 to receive GNSS signals from a GNSS network (e.g., GNSS network 18 of FIG. 1), including one or more GNSS satellites (e.g., GNSS satellites 20 of FIG. 1) or GNSS ground stations. The GNSS signals may include a GNSS satellite's observation data, broadcast orbit information of tracked GNSS satellites, and supporting data, such as meteorological parameters, collected from co-located instruments of a GNSS satellite. For example, the GNSS signals may be received from a Global Positions System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on.

As described above, the GNSS receiver 48 may receive GNSS signals from the GNSS satellites 20 and process the signals to determine a global position of the user equipment 12. In particular, each GNSS satellite 20 may transmit one or more pilot channels alongside a data signal. Each pilot channel is a dataless signal transmitted from a corresponding GNSS satellite 20. The user equipment 12 may process one or more of the pilot channels from one or more GNSS satellites 20 to determine the position of the user equipment 12.

The GNSS receiver 48 may process the received pilot channels of the GNSS signals from each GNSS satellite 20 to amplify the power of the pilot channels, generate and maintain tracking loops for each pilot channel, and determine the position of the user equipment 12 based on each pilot channel. For instance, the GNSS receiver 48 may amplify the power of the pilot channels and generate the tracking loop for each pilot channel by performing a series of signal processing operations based on the received pilot channel. The GNSS receiver 48 may then perform a radio frequency (RF) down-conversion operation, a sampling operation, a Doppler removal operation, a coherent signal integration operation, and a non-coherent summation operation based on the received pilot channel. However, in certain embodiments, it should be understood that the GNSS receiver 48 may perform the signal processing operations in different sequences than the sequence described, and certain operations may be skipped or not performed altogether.

The GNSS receiver 48 may include a frequency stability prediction engine, which may be implemented as hardware (e.g., circuitry), software (e.g., instructions stored in the memory 24 and/or the storage 26), or both (e.g., as logic). As mentioned above, during the coherent signal integration operation performed by the GNSS receiver 48 against a pilot channel of a received GNSS signal, the GNSS receiver 48 integrates the pilot channel over a coherent period of time to generate a resulting signal with a particular signal to noise ratio (SNR). Thereafter, during the non-coherent summation operation, the resulting signal is squared to increase the signal gain. Generally, a higher SNR in the resulting signal generated from the coherent signal integration operation will minimize a squaring loss that is incurred in the resulting signal from squaring the noise present in the resulting signal during the noncoherent summation operation. As such, by minimizing the squaring loss in the resulting signal from the non-coherent summation operation, the quality of the signal is increased, thereby increasing an accuracy in determining the position of the user equipment.

However, a number of factors may affect the signal during the coherent signal integration operation, which can decrease the SNR in the resulting signal. For instance, such factors may affect oscillator dynamics of the user equipment 12, such as motion experienced by a reference oscillator of the GNSS receiver 48 or thermal changes experienced by the reference oscillator of the GNSS receiver 48, and user dynamics associated with the user equipment 12, such as motion of the user equipment 12, thermal changes associated with the user equipment 12, and the like. Accordingly, the frequency stability prediction engine of the GNSS receiver 48 may dynamically adjust the coherent period of time for performing the coherent signal integration operation against the pilot channel of the GNSS signal based on various types of data associated with the user equipment 12. For instance, the frequency stability prediction engine of the GNSS receiver 48 may receive data from one or more sensors 37 associated with the user equipment 12 that are indicative of current and/or expected conditions associated with the user equipment 12 (e.g., motion, temperature, light, pressure, and so on). In certain embodiments, the data may be indicative of a temperature associated with the reference oscillator of the GNSS receiver 48, the user equipment, or both; an expected change in temperature associated with the reference oscillator of the GNSS receiver 48, the user equipment, or both; a motion associated with the reference oscillator of the GNSS receiver 48, the user equipment, or both; an expected change in motion associated with the reference oscillator of the GNSS receiver 48, the user equipment, or both; or the like.

In some embodiments, the user equipment 12 may determine a current motion associated with the user equipment 12 or an expected motion associated with the user equipment 12 based on data from the sensors 37. For instance, the user equipment 12 may determine an orientation, a position, or both, of the user equipment 12 with respect to a user of the user equipment 12. The user equipment 12 may determine that the orientation or the position of the user equipment 12 is indicative of a stationary orientation or position of the user equipment 12, a changing orientation or position of the user equipment 12, or the like. For instance, the user equipment 12 may determine that the user is holding the user equipment 12 in a hand of the user, the user is walking with the user equipment 12 in a hand of the user, the user is jogging with the user equipment 12 in a hand of the user, the user is running with the user equipment 12 in a hand of the user, the user is carrying the user equipment 12 in a pocket of the user, the user is walking with the user equipment 12 in a pocket of the user, the user is jogging with the user equipment 12 in a pocket of the user, the user is running with the user equipment 12 in a pocket of the user, the user is driving a vehicle with the user equipment 12 in the vehicle, and the like. The frequency stability prediction engine of the GNSS receiver 48 may receive data indicative of the orientation or the position of the user equipment 12 from the user equipment 12 (e.g., the processor 22, the memory 24, the storage 26).

The frequency stability prediction engine of the GNSS receiver 48 may also receive other suitable types of data or information from the user equipment 12 that are indicative of factors that may affect the pilot channel of the GNSS signal during the coherent signal integration operation. For instance, the frequency stability prediction engine of the GNSS receiver 48 may receive data indicative of an upcoming transmission from an antenna associated with the user equipment 12, data indicative of a powering down of an antenna associated with the user equipment 12, data indicative of a powering on of a cellular power amplifier associated with the user equipment 12, data indicative of a powering down of a cellular power amplifier associated with the user equipment 12, or the like. The frequency stability prediction engine may receive information indicating the current or predicted oscillator temperature from the thermal manager.

After receiving data associated with the user equipment 12 that may be indicative of one or more factors that may affect the pilot channel of the GNSS signal during the coherent signal integration operation, the frequency stability prediction engine of the GNSS receiver 48 may determine a corresponding period of time (e.g., a coherent period of time) for performing the coherent signal integration operation (e.g., coherent operation) against the pilot channel of the GNSS signal. In certain embodiments, the frequency stability predication engine of the GNSS receiver 48 may compare the data received from the user equipment 12 pre-defined values of the coherent period of time (e.g., stored in a look-up table in the memory 24 or the storage 26). For instance, the different values for the coherent period of time may be associated with one or more data inputs indicative of the respective factors that may affect the pilot channel of the GNSS signal during the coherent signal integration operation. In some embodiments, the values of the coherent period may be pre-determined by a manufacturer of the user equipment 12. In other embodiments, the user equipment 12 may receive one or more updates to the values over time to update the values of the coherent period that correspond to the data inputs indicative of the respective factors that may affect the pilot channel of the GNSS signal during the coherent signal integration operation.

After the frequency stability prediction engine of the GNSS receiver 48 determines a corresponding coherent period of time for performing the coherent signal integration operation against the pilot channel of the GNSS signal, the GNSS receiver 48 may perform the coherent signal integration against the pilot channel of the GNSS signal using the determined coherent period of time. By adjusting the coherent period of time for performing the coherent signal integration operation to account for current and/or expected conditions associated with the user equipment 12, a higher SNR of the resulting signal may be obtained. In this way, the squaring loss that is incurred in the resulting signal from squaring any noise present in the resulting signal during the subsequent non-coherent summation operation may be decreased or minimized, thereby increasing the quality of the signal for determining the position of the user equipment 12.

The user equipment 12 may also have one or more antennas 46A-46N (collectively 46) electrically coupled to the cellular transceiver 38, and one or more antennas 50A-50N (collectively 50) electrically coupled to the GNSS receiver 48. The antennas 46, 50 may be configured in an omnidirectional or directional configuration, in a single-beam, dualbeam, or multi-beam arrangement, and so on. Each antenna 46, 50 may be associated with one or more beams and various configurations. In some embodiments, multiple antennas of the antennas 46, 50 of an antenna group or module may be communicatively coupled to a respective transceiver 38 or the GNSS receiver 48 and each emit radio frequency signals that may constructively and/or destructively combine to form a beam. The user equipment 12 may include multiple transmitters, multiple receivers, multiple transceivers, and/or multiple antennas as suitable for various communication standards.

As illustrated, the various components of the user equipment 12 may be coupled together by a bus system 54. The bus system 54 may include a data bus, for example, as well as a power bus, a control signal bus, and a status signal bus, in addition to the data bus. The components of the user equipment 12 may be coupled together or accept or provide inputs to each other using some other mechanism.

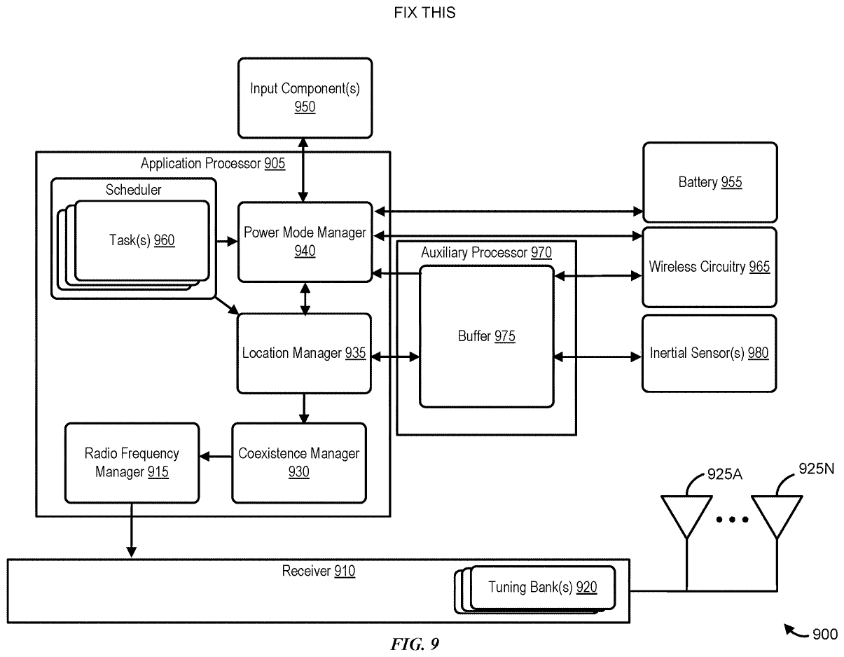

FIG. 9 is a simplified diagram of an architecture 900 for GNSS navigation according to various embodiments. Processes executing on application processor 905 can implement tuning logic and instruct receiver 910 to perform GNSS measurements using the GNSS circuitry or change the tuning state for one or more antennas. Application processor 905 can be part of a mobile device such as user equipment 12. In addition, receiver 910 can be similar to receiver 48 and application processor 905 and auxiliary processor 970 can be similar to processor 22 described above. Instructions to the receiver 910 can be sent by a radio frequency manager 915 and the receiver can perform GNSS measurements or connect or disconnect one or more of the tuning bank(s) 920 to the antennas 925a-925n in response to the instructions. Changing the tuning bank(s) 920 can change the tuning state for the antennas 925a-925n and the performing GNSS measurements may involve changing the tuning state for these antennas.

The tuning logic can be implemented by the coexistence manager 930 which can integrate information from the other processes executing on processor 905 to make decisions about changing the tuning state. Upon determining that the tuning state should change, the coexistence manager 930 can instruct the radio frequency manger to change the tuning state for antennas 925a-925n. The tuning logic can include changing the tuning state based on the GNSS mode (e.g., acquisition, or tracking), the thermal state (e.g., thermal event; whether temperature is stable or fluctuating), or the power state of the mobile device (e.g. the charge in the device's battery; whether the device is charging).

Location manager 935 can process signals received at the antennas and provide information about the current GNSS mode to the coexistence manager 930. Signals received at the antennas 925a-925n can be forwarded to the location manager 935 via receiver 910, radio frequency manager 915, and coexistence manager 930. The location manager 935, the antennas 925a-925n, receiver 910, radio frequency manager 915, and coexistence manager 930 can be collectively referred to as the GNSS circuitry. The location manager can interpret the signals and determine a location for the mobile device. The location manager can implement the measurement engine, maximum likelihood path selector, estimators and path delays shown in FIG. 5. The location manager can generate correlator outputs and identify peaks in some embodiments.

The location manager 935 can request location functionality from the coexistence manager 930. For instance, the location manager 935 can receive a request for location functionality from one or more scheduled task(s) 960. In response to the request, the location manager can request information about signals received at the antennas 925a-925n from the location manager 935. In response, the coexistence manager 930 can request that the radio frequency manager 915 acquire a connection with a satellite and perform tracking. The request from the coexistence manager 930 can include an instruction to change the tuning state or tracking mode depending on the current tracking mode.

Power mode manager 940 can cause the application processor to enter or exit a low power state to conserve power. In a low power state, the power mode manager 940 may limit the frequency (e.g., clock speed) of one or more of the processing units (e.g., cores) in the application processor 905. When the application processor 905 is in a low power state, tasks intended for the application processor 905 can be stored in a buffer 945 by the auxiliary processor 970. When the application processor 905 leaves the low-power mode, the application processor 905 can process the queued tasks. The tasks can be queued by the auxiliary processor 970 which can be a processor that is powered on more frequently than the application processor 905 (e.g., the application processor 905 is powered on less frequently than the auxiliary processor).

The power mode manager 940 can use one or more rules to cause the application processor 905 to enter or exit the low power state. For example, the power mode manager 940 can cause the application processor 905 to enter the low power state based on information received from input component(s) 950. For example, the input component(s) 950 can include one or more touchscreens, touchpads, or buttons and the power mode manager 940 may cause the application processor 905 to enter a low power state if the input to these devices is below an input threshold. The power mode manager 940 may monitor the state of battery 955 and the input threshold may change depending on the current capacity of battery 955. For example, the input threshold may be higher when the capacity of battery 955 is below a battery threshold.

In addition, the power mode manager 940 can monitor scheduled task(s) 960 from one or more application(s) to determine whether to cause the application processor 905 to enter the low power state. For example, the power mode manager 940 may not enter the low power state if a threshold number of tasks(s) 960 for the application(s) are scheduled for execution on the application processor. The priority of the application(s), or the priority of the scheduled task(s) 960, may determine whether the power mode manager 940 causes the application processor 905 to enter the low power state. In addition, the threshold number of scheduled task(s) 960 may vary based on the capacity of battery 955 (e.g., whether the capacity is above or below one or more thresholds). Any combination of the techniques described with reference to the power mode manager 940 may be used to determine whether to cause the power mode manager 940 to instruct the application processor 905 to enter the low power state.

The power mode manager 940 can cause the application processor 905 to exit the low power state based on information received from input component(s) 950. For example, the power mode manager 940 may cause the application processor 905 to exit a low power state if the input to these devices is above an input threshold. The power mode manager 940 may monitor the state of battery 955 and the input threshold may change depending on the current capacity of battery 955. For example, the input threshold may be higher when the capacity of battery 955 is below a battery threshold. The battery threshold for entering the low power state may be higher or lower than the input threshold for leaving the low power state. In addition, the power mode manager 940 can monitor scheduled task(s) 960 from one or more application(s) to determine whether to cause the application processor 905 to exit the low power state. For example, the power mode manager 940 may exit the low power state if a threshold number of tasks(s) 960 for the application(s) are scheduled for execution on the application processor. The priority of the application(s), or the priority of the scheduled task(s) 960, may determine whether the power mode manager 940 causes the application processor 905 to exit the low power state. In addition, the threshold number of scheduled task(s) 960 may vary based on the capacity of battery 955 (e.g., whether the capacity is above or below one or more thresholds).

The power mode manager 940 may exit the low power state in response to input from the wireless circuitry 965. For example, the power mode manager 940 may cause the application processor 905 to leave the low power state if information from the wireless circuitry 965 indicates that the device has connected or disconnected from a wireless access point. In addition, the auxiliary processor 970 may instruct the power mode manager 940 to wake the application processor 905. For example, the auxiliary processor 970 may provide information about the capacity of buffer 975 to the power mode manager 940, and the power mode manager 940 may wake the application processor 905 if the capacity of buffer 975 is above a threshold. In some embodiments, the power mode manager 940 may wake (e.g., cause the application processor to exit the low power state) at regular intervals. Any combination of the techniques described with reference to the power mode manager 940 may be used to determine whether to cause the power mode manager 940 to instruct the application processor 905 to exit the low power state.

The wireless circuitry 965 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 965 can use various protocols, e.g., as described herein. In various embodiments, wireless circuitry 965 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

### III. Example Device

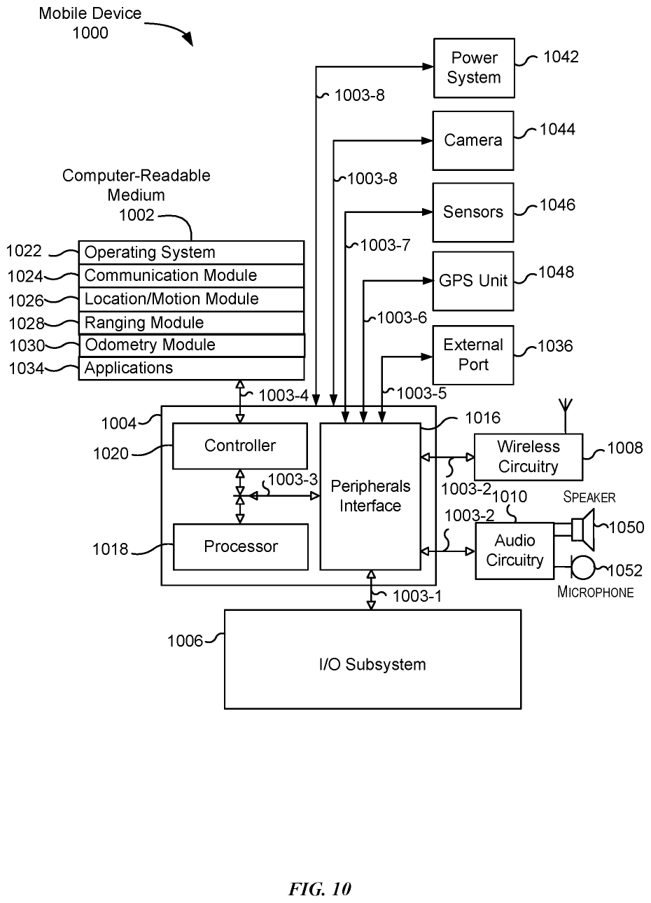

FIG. 10 is a block diagram of an example electronic device 1000 according to various embodiments. Device 1000 generally includes computer-readable medium 1002, a processing system 1004, an Input/Output (I/O) subsystem 1006, wireless circuitry 1008, and audio circuitry 1010 including speaker 1010 and microphone 1014. These components may be coupled by one or more communication buses or signal lines 1003. Device 1000 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 10 is only one example of an architecture for device 1000, and that device 1000 can have more or fewer components than shown, or a different configuration of components. The various components shown in FIG. 10 can be implemented in hardware, software, or a combination of both hardware and software, including one or more signal processing and/or application specific integrated circuits.

Wireless circuitry 1008 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1008 can use various protocols, e.g., as described herein. In various embodiments, wireless circuitry 1008 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1008 is coupled to processing system 1004 via peripherals interface 1016. Peripherals interface 1016 can include conventional components for establishing and maintaining communication between peripherals and processing system 1004. Voice and data information received by wireless circuitry 1008 (e.g., in speech recognition or voice command applications) is sent to one or more processors 1018 via peripherals interface 1016. One or more processors 1018 are configurable to process various data formats for one or more application programs 1034 stored on medium 1002.

Peripherals interface 1016 couple the input and output peripherals of device 1000 to the one or more processors 1018 and computer-readable medium 1002. One or more processors 1018 communicate with computer-readable medium 1002 via a controller 1020. Computer-readable medium 1002 can be any device or medium that can store code and/or data for use by one or more processors 1018. Computer-readable medium 1002 can include a memory hierarchy, including cache, main memory and secondary memory. The memory hierarchy can be implemented using any combination of random access memory (RAM) (e.g., static random access memory (SRAM) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 1016, one or more processors 1018, and controller 1020 can be implemented on a single chip, such as processing system 1004. In some other embodiments, they can be implemented on separate chips.

Processor(s) 1018 can include hardware and/or software elements that perform one or more processing functions, such as mathematical operations, logical operations, data manipulation operations, data transfer operations, controlling the reception of user input, controlling output of information to users, or the like. Processor(s) 1018 can be embodied as one or more hardware processors, microprocessors, microcontrollers, field programmable gate arrays (FPGAs), application-specified integrated circuits (ASICs), or the like.

Device 1000 also includes a power system 1042 for powering the various hardware components. Power system 1042 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1000 includes a camera 1044. In some embodiments, device 1000 includes sensors 1046. Sensors can include accelerometers, compass, gyrometer, pressure sensors, audio sensors, light sensors, barometers, and the like. Sensors 1046 can be used to sense location aspects, such as auditory or light signatures of a location.

In some embodiments, device 1000 can include a GPS receiver, sometimes referred to as a GPS unit 1048. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1018 run various software components stored in medium 1002 to perform various functions for device 1000. In some embodiments, the software components include an operating system 1022, a communication module 1024 (or set of instructions), a location module 1026 (or set of instructions), a ranging module 1028 that is used as part of ranging operation described herein, and other application programs 1034 (or set of instructions).

Operating system 1022 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1024 facilitates communication with other devices over one or more external ports 1036 or via wireless circuitry 1008 and includes various software components for handling data received from wireless circuitry 1008 and/or external port 1036. External port 1036 (e.g., universal serial bus (USB), FireWire, Lightning connector, 70-pin connector, etc.) is adapted for coupling directly to other devices or indirectly over a network (e.g., the Internet, wireless local area network (LAN), etc.).

Location/motion module 1026 can assist in determining the current position (e.g., coordinates or other geographic location identifiers) and motion of device 1000. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1026 receives data from GPS unit 1048 and analyzes the signals to determine the current position of the mobile device. In some embodiments, location/motion module 1026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1008 and is passed to location/motion module 1026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1000 based on the position coordinates of the corresponding transmitters. Regardless of the specific location technology used, location/motion module 1026 receives information from which a location fix can be derived, interprets that information, and returns location information, such as geographic coordinates, latitude/longitude, or other location fix data.

Ranging module 1028 can send/receive ranging messages to/from an antenna, e.g., connected to wireless circuitry 1008. The messages can be used for various purposes, e.g., to identify a sending antenna of a device, determine timestamps of messages to determine a distance of electronic device 1000 from another device. Ranging module 1028 can exist on various processors of the device, e.g., an always-on processor (AOP), a UWB chip, and/or an application processor. For example, parts of ranging module 1028 can determine a distance on an AOP, and another part of the ranging module can interact with a sharing module, e.g., to display a position of the other device on a screen in order for a user to select the other device to share a data item. Ranging module 1028 can also interact with a reminder module that can provide an alert based on a distance from another mobile device.

Odometry module 1030 can perform odometry techniques to determine the location and orientation of electronic device 1000 within a physical environment. Output from the camera 1044 and the sensors 1046 can be accessed by the odometry module 1030, and the odometry module 1030 can use this information to perform visual inertial odometry techniques. The odometry module 1030 can identify and compare features in sequential images captured by camera 1044 to determine the camera's movement relative to those features. The odometry module 1030 may use information from the sequential images to create a map of the environment. In addition or alternatively, inertial information from sensors 1046 can be used to estimate the movement of the electronic device 1000. Inertial information can include any combination of linear acceleration, angular acceleration, linear velocity, angular velocity, and magnetometer readings, and the inertial information can be in any number of axes.

The one or more applications 1034 on device 1000 can include any applications installed on the device 1000, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1006 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1006 can include a display and user input devices such as a keyboard, mouse, and/or trackpad. In some embodiments, I/O subsystem 1006 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1006 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1000 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

### IV. API Interfaces

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 1160) that, when executed by one or more processing units, control an electronic device (e.g., device 1150) to perform the method of FIG. 11A, the method of FIG. 11B, and/or one or more other processes and/or methods described herein.

It should be recognized that application 1160 (shown in FIG. 11C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 1160 is an application that is pre-installed on device 1150 at purchase (e.g., a first party application). In other embodiments, application 1160 is an application that is provided to device 1150 via an operating system update file (e.g., a first party application or a second party application). In other embodiments, application 1160 is an application that is provided via an application store. In some embodiments, the application store can be an application store that is pre-installed on device 1150 at purchase (e.g., a first party application store). In other embodiments, the application store is a third-party application store (e.g., an application store that is provided by another application store, downloaded via a network, and/or read from a storage device).

Referring to FIG. 11A and FIG. 11E, application 1160 obtains information (e.g., S1110). In some embodiments, at S1110, information is obtained from at least one hardware component of the device 1150. In some embodiments, at S1110, information is obtained from at least one software module of the device 1150. In some embodiments, at S1110, information is obtained from at least one hardware component external to the device 1150 (e.g., a peripheral device, an accessory device, a server, etc.). In some embodiments, the information obtained at S1110 includes positional information, time information, notification information, user information, environment information, electronic device state information, weather information, media information, historical information, event information, hardware information, and/or motion information. In some embodiments, in response to and/or after obtaining the information at S1110, application 1160 provides the information to a system (e.g., S1120).

In some embodiments, the system (e.g., 1110 shown in FIG. 11D) is an operating system hosted on the device 1150. In some embodiments, the system (e.g., 1110 shown in FIG. 11D) is an external device (e.g., a server, a peripheral device, an accessory, a personal computing device, etc.) that includes an operating system.

Referring to FIG. 11B and FIG. 11F, application 1160 obtains information (e.g., S1130). In some embodiments, the information obtained at S1130 includes positional information, time information, notification information, user information, environment information electronic device state information, weather information, media information, historical information, event information, hardware information and/or motion information. In response to and/or after obtaining the information at S1130, application 1160 performs an operation with the information (e.g., S1140). In some embodiments, the operation performed at S1140 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1110 based on the information.

In some embodiments, one or more steps of the method of FIG. 11A and/or the method of FIG. 11B is performed in response to a trigger. In some embodiments, the trigger includes detection of an event, a notification received from system 1110, a user input, and/or a response to a call to an API provided by system 1110.

In some embodiments, the instructions of application 1160, when executed, control device 1150 to perform the method of FIG. 11A and/or the method of FIG. 11B by calling an application programming interface (API) (e.g., API 1190) provided by system 1110. In some embodiments, application 1160 performs at least a portion of the method of FIG. 11A and/or the method of FIG. 11B without calling API 1190.

In some embodiments, one or more steps of the method of FIG. 11A and/or the method of FIG. 11B includes calling an API (e.g., API 1190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 11C, device 1150 is illustrated. In some embodiments, device 1150 is a personal computing device, a smart phone, a smart watch, a fitness tracker, a head mounted display (HMD) device, a media device, a communal device, a speaker, a television, and/or a tablet. As illustrated in FIG. 11C, device 1150 includes application 1160 and operating system (e.g., system 1110 shown in FIG. 11D). Application 1160 includes application implementation module 1170 and API calling module 1180. System 1110 includes API 1190 and implementation module 1100. It should be recognized that device 1150, application 1160, and/or system 1110 can include more, fewer, and/or different components than illustrated in FIGS. 11C and 11D.

In some embodiments, application implementation module 1170 includes a set of one or more instructions corresponding to one or more operations performed by application 1160. For example, when application 1160 is a messaging application, application implementation module 1170 can include operations to receive and send messages. In some embodiments, application implementation module 1170 communicates with API calling module to communicate with system 1110 via API 1190 (shown in FIG. 11D).

In some embodiments, API 1190 is a software module (e.g., a collection of computer-readable instructions) that provides an interface that allows a different module (e.g., API calling module 1180) to access and/or use one or more functions, methods, procedures, data structures, classes, and/or other services provided by implementation module 1100 of system 1110. For example, API-calling module 1180 can access a feature of implementation module 1100 through one or more API calls or invocations (e.g., embodied by a function or a method call) exposed by API 1190 and can pass data and/or control information using one or more parameters via the API calls or invocations. In some embodiments, API 1190 allows application 1160 to use a service provided by a Software Development Kit (SDK) library. In other embodiments, application 1160 incorporates a call to a function or method provided by the SDK library and provided by API 1190 or uses data types or objects defined in the SDK library and provided by API 1190. In some embodiments, API-calling module 1180 makes an API call via API 1190 to access and use a feature of implementation module 1100 that is specified by API 1190. In such embodiments, implementation module 1100 can return a value via API 1190 to API-calling module 1180 in response to the API call. The value can report to application 1160 the capabilities or state of a hardware component of device 1150, including those related to aspects such as input capabilities and state, output capabilities and state, processing capability, power state, storage capacity and state, and/or communications capability. In some embodiments, API 1190 is implemented in part by firmware, microcode, or other low level logic that executes in part on the hardware component.

In some embodiments, API 1190 allows a developer of API-calling module 1180 (which can be a third-party developer) to leverage a feature provided by implementation module 1100. In such embodiments, there can be one or more API-calling modules (e.g., including API-calling module 1180) that communicate with implementation module 1100. In some embodiments, API 1190 allows multiple API-calling modules written in different programming languages to communicate with implementation module 1100 (e.g., API 1190 can include features for translating calls and returns between implementation module 1100 and API-calling module 1180) while API 1190 is implemented in terms of a specific programming language. In some embodiments, API-calling module 1180 calls APIs from different providers such as a set of APIs from an OS provider, another set of APIs from a plug-in provider, and/or another set of APIs from another provider (e.g., the provider of a software library) or creator of the another set of APIs.

Examples of API 1190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1100 is an system (e.g., operating system, server system) software module (e.g., a collection of computer-readable instructions) that is constructed to perform an operation in response to receiving an API call via API 1190. In some embodiments, implementation module 1100 is constructed to provide an API response (via API 1190) as a result of processing an API call. By way of example, implementation module 1100 and API-calling module 180 can each be any one of an operating system, a library, a device driver, an API, an application program, or other module. It should be understood that implementation module 1100 and API-calling module 1180 can be the same or different type of module from each other. In some embodiments, implementation module 1100 is embodied at least in part in firmware, microcode, or other hardware logic.

In some embodiments, implementation module 1100 returns a value through API 1190 in response to an API call from API-calling module 1180. While API 1190 defines the syntax and result of an API call (e.g., how to invoke the API call and what the API call does), API 1190 might not reveal how implementation module 1100 accomplishes the function specified by the API call. Various API calls are transferred via the one or more application programming interfaces between API-calling module 1180 and implementation module 1100. Transferring the API calls can include issuing, initiating, invoking, calling, receiving, returning, and/or responding to the function calls or messages. In other words, transferring can describe actions by either of API-calling module 1180 or implementation module 1100. In some embodiments, a function call or other invocation of API 1190 sends and/or receives one or more parameters through a parameter list or other structure.

In some embodiments, implementation module 1100 provides more than one API, each providing a different view of or with different aspects of functionality implemented by implementation module 1100. For example, one API of implementation module 1100 can provide a first set of functions and can be exposed to third party developers, and another API of implementation module 1100 can be hidden (e.g., not exposed) and provide a subset of the first set of functions and also provide another set of functions, such as testing or debugging functions which are not in the first set of functions. In some embodiments, implementation module 1100 calls one or more other components via an underlying API and thus be both an API calling module and an implementation module. It should be recognized that implementation module 1100 can include additional functions, methods, classes, data structures, and/or other features that are not specified through API 1190 and are not available to API calling module 1180. It should also be recognized that API calling module 1180 can be on the same system as implementation module 1100 or can be located remotely and access implementation module 1100 using API 1190 over a network. In some embodiments, implementation module 1100, API 1190, and/or API-calling module 1180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, any of methods 101 (FIG. 1) and method 500 (FIG. 5) are performed at a first computer system (as described herein) via a system process (e.g., an operating system process, a server system process) that is different from one or more applications executing and/or installed on the first computer system.

In some embodiments, any of methods 101 (FIG. 1) and method 500 (FIG. 5) are performed at a first computer system (as described herein) by an application that is different from a system process. In some embodiments, the instructions of the application, when executed, control the first computer system to perform any of methods any of methods 101 (FIG. 1) and method 500 (FIG. 5) by calling an application programming interface (API) provided by the system process. In some embodiments, the application performs at least a portion of any of methods 101 (FIG. 1) and method 500 (FIG. 5) without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1190 defines a first API call that can be provided by API calling module 1190. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1150) that runs the application. In some embodiments, the implementation module is included in an electronic device that is separate from the device that runs the application.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method comprising:
receiving global navigation satellite system (GNSS) data;
receiving inertial data that is measured by an electronic device;
determining that the electronic device is recording pedestrian activity of a particular type;
determining that the electronic device is in a particular signal environment; and
responsive to determining that the electronic device is recording the pedestrian activity in the particular signal environment, generating calibrated movement data by:
calibrating the inertial data using the global navigation satellite system (GNSS) data.

2. The method of claim 1, wherein generating the calibrated movement data further comprises:
removing outliers from the global navigation satellite system (GNSS) data using the calibrated inertial data.

3. The method of claim 1, further comprising:
computing a distance and a pace for the pedestrian activity using the calibrated movement data.

4. The method of claim 1, wherein determining that the electronic device is in the particular signal environment comprises:
determining a tile in a map that corresponds to the global satellite navigation system (GNSS) data;
accessing signal environment information for the tile; and
determining that the electronic device is in the particular signal environment based on the signal environment information.

5. The method of claim 1, wherein receiving the GNSS data further comprises:
determining one or more GNSS signal conditions.

6. The method of claim 5, wherein the GNSS signal conditions comprise one or more of:
a GNSS signal strength;
an elevation;
an azimuth; and
one or more multipath indicators.

7. The method of claim 6, wherein determining that the electronic device is in the particular signal environment comprises:
comparing the one or more GNSS signal conditions against one or more thresholds to identify the particular signal environment.

8. The method of claim 4, further comprising:
displaying a path of the pedestrian activity on the map using the calibrated movement data.

9. The method of claim 1, wherein the particular type is a walk, a hike, or a run.

10. The method of claim 1, wherein the particular signal environment is a dense urban environment, a tunnel, or a canyon.

11. The method of claim 1, wherein the global navigation satellite system (GNSS) data is collected at a 1 hertz (Hz) frequency.

12. The method of claim 1, wherein the global navigation satellite system (GNSS) data is measured by a first processor of the electronic device, and the inertial data is measured by a second processor of the electronic device, wherein the second processor is active for a larger proportion of time than the first processor.

13. The method of claim 1, wherein the particular signal environment is an obstructed signal environment.

14. The method of claim 1, wherein the particular signal environment is an urban signal environment.

15. The method of claim 1, wherein determining the pedestrian activity of the particular type comprises:
determining a carrying type and a gait type for the pedestrian activity, wherein the carrying type includes one of hand carrying and pocket carrying, and wherein the gait type includes one of walking, stair climbing, and running.

16. One or more non-transitory computer-readable media comprising computer-executable instructions that, when executed by one or more processors of an electronic device, cause the electronic device to perform operations comprising:
receiving global navigation satellite system (GNSS) data;
receiving inertial data that is measured by an electronic device;
determining that the electronic device is recording pedestrian activity of a particular type;
determining that the electronic device is in a particular signal environment; and
responsive to determining that the electronic device is recording the pedestrian activity in the particular signal environment, generating calibrated movement data by:
calibrating the inertial data using the global navigation satellite system (GNSS) data.

17. The one or more non-transitory computer-readable media of claim 16, wherein generating the calibrated movement data further comprises:
removing outliers from the global navigation satellite system (GNSS) data using the calibrated inertial data.

18. The one or more non-transitory computer-readable media of claim 16, wherein determining that the electronic device is in the particular signal environment comprises:
determining a tile in a map that corresponds to the global satellite navigation system (GNSS) data;
accessing signal environment information for the tile; and
determining that the electronic device is in the particular signal environment based on the signal environment information.

19. A mobile device comprising:
a memory comprising computer-executable instructions; and
a processor configured to access the memory and execute the computer-executable instructions to perform operations comprising:
receiving global navigation satellite system (GNSS) data;
receiving inertial data that is measured by an electronic device;
determining that the electronic device is recording pedestrian activity of a particular type;
determining that the electronic device is in a particular signal environment; and
responsive to determining that the electronic device is recording the pedestrian activity in the particular signal environment, generating calibrated movement data by:
calibrating the inertial data using the global navigation satellite system (GNSS) data.

20. The mobile device of claim 19, wherein determining that the electronic device is in the particular signal environment comprises:
determining a tile in a map that corresponds to the global satellite navigation system (GNSS) data;
accessing signal environment information for the tile; and
determining that the electronic device is in the particular signal environment based on the signal environment information.
